(19) United States
(12) Patent Application Publication
(10) Pub. No.: US 2025/0362463 A1
(43) Pub. Date: Nov. 27, 2025

(54) INTEGRATED CONNECTOR WITH PRE-ALIGNMENT EXTERNAL SHROUD AND FIBER POST ENGAGEMENT

(71) Applicant: Cilag Gmbh International, Zug (CH)

(72) Inventors: Dillon Karg, Santa Clara, CA (US); Jeremiah D. Henley, Fair Oaks, CA (US); Niko Murrell, Blue Ash, OH (US); Logan Gilbert, Santa Clara, CA (US)

(73) Assignee: Cilag Gmbh International, Zug (CH)

(21) Appl. No.: 18/670,381

(22) Filed: May 21, 2024

(51) Int. Cl. G02B 6/42

(52) U.S. Cl. CPC G02B 6/423; G02B 6/4221; G02B 6/4269; G02B 6/4278; G02B 6/4293

(57) ABSTRACT

Integrated connector for coupling an endoscope to an external emitter and controller. A system includes a plug attached to a cable, wherein the plug includes an alignment shroud, a first fiber optic coupler, and a first data connector. The system includes a receptacle configured to receive the plug, wherein the receptacle includes an alignment receptacle configured to receive the alignment shroud, wherein the alignment receptacle is a negative space defined by a receptacle external shroud and a receptacle internal shroud, a second fiber optic coupler configured to interface with the first fiber optic coupler, and a second data connector configured to interface with the first data connector.

### TECHNICAL FIELD

This disclosure is directed to coupling components and, more particularly but not entirely, to an integrated connector module for connecting electrical components and fiber optic components of an endoscopic visualization system.

### BACKGROUND

Endoscopic surgical instruments are often preferred over traditional open surgical devices because the small incision tends to reduce post-operative recovery time and associated complications. In some instances of endoscopic visualization, it is desirable to view a space with high-definition color imaging and further with one or more advanced visualization techniques providing additional information that cannot be discerned with the human eye. In many cases, and particularly when image data is utilized by a robotic surgical system, it is desirable to extract dimensional information from the scene using stereoscopic imaging, laser mapping, or some other means. However, these advanced visualization techniques require specialized components, and the space-constrained environment of an endoscope introduces numerous technical challenges when seeking to capture advanced visualization data of a surgical scene.

The endoscopic systems, methods, and devices described herein utilize multiple illumination sources to provide one or more of color visualization, fluorescence visualization, multispectral visualization, and the capture of dimensional information. Additionally, the endoscopic systems, methods, and devices described herein may be implemented with off-camera computer processing to control operations of the endoscope and implement image processing corrections. The numerous illumination sources and the off-camera computer processing may be housed away from the endoscope itself such that these components can avoid undergoing rigorous sterilization processes prior to each use of the endoscope. However, this introduces a need to prepare one or more plugs for connecting the endoscope to the illumination and processing components.

Traditional endoscopic systems do not utilize external light sources and processing or provide separate coupling mechanisms for connecting the endoscope to the external components. Some traditional systems utilize a connector that seeks to couple optical components and electronic components. However, these traditional systems fail to implement a sequential, rather than simultaneous, coupling procedure for pre-aligning the connectors, pre-aligning the optical coupling components, engaging the optical coupling components, pre-aligning the electronic coupling components, and engaging the electronic coupling components.

For example, U.S. Pat. No. 10,631,713, entitled “MULTI-STAGE INSTRUMENT CONNECTOR,” with a provisional filing date of Mar. 17, 2014, describes a connector for a medical device that provides pathways for high intensity illumination and imaging controls or captured data. However, this disclosure does not describe a connector comprising an alignment shroud and corresponding alignment receptacle for providing pre-alignment of optical coupling components and data coupling components. Additionally, this disclosure does not describe wherein optical coupling components and data coupling components are pre-aligned, roughly aligned, and engaged in a stepwise fashion to protect delicate components.

What is needed is an integrated connector capable of coupling optical components and electrical components such that electromagnetic radiation (EMR) and data can travel between an endoscope and an illumination source or computer processor. In view of the foregoing, disclosed herein are systems, methods, and devices for an integrated connector with pre-alignment components for sequential engagement of optical coupling components and data coupling components.

### BRIEF DESCRIPTIONS OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1A is a schematic illustration of an example system for endoscopic visualization with color imaging and advanced imaging;

FIG. 1B is a schematic illustration of an example image pickup portion of a system for endoscopic visualization with color imaging and advanced imaging;

FIG. 1C is a schematic illustration of an example emitter and controller of a system for endoscopic visualization with color imaging and advanced imaging;

FIG. 2A is a schematic block diagram of an example data flow for a time-sequenced visualization system;

FIG. 2B is a schematic block diagram of an example data flow for a time-sequenced visualization system;

FIG. 2C is a schematic flow chart diagram of a data flow for capturing and reading out data for a time-sequenced visualization system;

FIG. 3A is a schematic block diagram of an example system for processing data output by an image sensor with a controller in communication with an emitter and the image sensor;

FIG. 3B is a schematic block diagram of an example system for processing data output by an image sensor to generate color imaging data and advanced imaging data;

FIG. 3C is a schematic block diagram of an example system for processing data through a memory buffer to provide data frames to an image signal processor at regular intervals;

FIG. 4 is a schematic diagram of an illumination system for illuminating a light deficient environment according to a variable pulse cycle;

FIG. 5 is a perspective view of an exterior of a connector module configured to enable optical and data connectivity between an endoscope and an external emitter and controller;

FIG. 6 is a perspective view of an exterior of a connector module and specifically illustrates wherein a cable connector plug attached to an endoscope is aligned to be plugged into a cable connector receptacle disposed within the housing of an emitter and controller;

FIG. 7 is a perspective view of a connector module and specifically illustrates a backside of a cable connector receptacle configured to receive a cable connector plug;

FIG. 8 is a perspective view of a connector module and specifically illustrates a cable connector receptacle configured to receive a cable connector plug;

FIG. 9 is an aerial top-down cross-sectional view of a connector module in a pre-alignment phase wherein the cable connector plug is not disposed within the cable connector receptacle;

FIG. 10 is an aerial top-down cross-sectional view of a connector module in a pre-alignment phase wherein corresponding optical coupling components and partially engaged with one another;

FIG. 11 is an aerial top-down cross-sectional view of a connector module in a pre-alignment phase wherein corresponding data coupling components are partially engaged with one another;

FIG. 12 is an aerial top-down cross-sectional view of a connector module in a fully coupled phase wherein corresponding optical coupling components are fully coupled, and further wherein corresponding data coupling components are fully coupled;

FIG. 13 is an aerial top-down cross-sectional view of a connector module and specifically illustrates a zoomed-in view of a portion of the optical coupling components in a fully coupled phase;

FIG. 14 is an aerial top-down cross-sectional view of a connector module and specifically illustrates a zoomed-in view of a portion of the data coupling components in a fully coupled phase;

FIG. 15 is a perspective cross-sectional view of a portion of the optical coupling components of a connector module, and specifically depicts an optical shutter of the connector module when the optical coupling components are not fully coupled;

FIG. 16 is a perspective cross-sectional view of a portion of the optical coupling components of a connector module, and specifically depicts an optical shutter of the connector module when the optical coupling components are not fully coupled; and

FIGS. 17A-17D are schematic cross-sectional illustrations of optical coupling components of a connector module in various degrees of coupling.

### DETAILED DESCRIPTION

Disclosed herein are systems, methods, and devices for connecting an endoscope unit to an external element. The external element may include one or more processors and may additionally include one or more illumination sources. Specifically disclosed herein are connection modules for facilitating both optical coupling and data coupling between an endoscope and a module comprising an emitter and a controller.

The connector module described herein includes alignment safeguards to guide a user into pre-aligning a plug with a corresponding receptacle prior to pressing the plug into the receptacle. The alignment safeguards include an alignment shroud and corresponding alignment receptacle that are configured to provide some tilt tolerance when the plug is inserted into the receptacle, but ultimately align the plug and receptacle to reduce the risk of damaging the optical coupling components or data coupling components during insertion. The alignment safeguards additionally include stepwise alignment of the optical coupling components. The stepwise alignment is implemented through staggered rivets machined into an exterior wall of a fiber optic post that is configured to be pressed into a corresponding fiber optic sleeve. The alignment safeguards additionally include a compliant data connector shroud disposed around a portion of the data coupling components. The data connector shroud aids in aligning corresponding data coupling components prior to engaging the data coupling components.

The connector module described herein is configured to sequentially, rather than simultaneously, couple the optical coupling components and the data coupling components. Specifically, the connector module is configured to first begin coupling corresponding optical coupling components prior to beginning to couple the corresponding data coupling components. This aids in ensuring proper alignment of the various coupling components and minimizes tilt error that can lead to damaging the delicate optical and electrical components.

Further disclosed herein are systems, methods, and devices for digital visualization that may be primarily suited to medical applications such as medical endoscopic imaging. An embodiment of the disclosure is an endoscopic system for color visualization and “advanced visualization” of a scene. The advanced visualization includes one or more of multispectral imaging, fluorescence imaging, or topographical mapping. Data retrieved from the advanced visualization may be processed by one or more algorithms configured to determine characteristics of the scene. The advanced visualization data may specifically be used to identify tissue structures within a scene, generate a three-dimensional topographical map of the scene, calculate dimensions of objects within the scene, identify margins and boundaries of different tissue types, and so forth.

An embodiment of the disclosure is an endoscopic visualization system that includes an emitter, an image sensor, and a controller. The emitter includes a plurality of separate and independently actuatable sources of EMR that may be separately cycled on and off to illuminate a scene with pulses of EMR. The image sensor accumulates photons and converts this reading to an electrical charge. The image sensor reads out the electrical charge data to generate a plurality of data frames. The controller synchronizes operations of the emitter and the image sensor to output a desired visualization scheme based on user input, which may be provided via a surgical display system. The visualization scheme may include a selection of one or more of color imaging, multispectral imaging, fluorescence imaging, topographical mapping, or anatomical measurement.

In some implementations of the system, the controller instructs the emitter and the image sensor to operate in a synchronized sequence to output a video stream that includes one or more types of visualization (i.e., color imaging, multispectral imaging, fluorescence imaging, topographical mapping, or anatomical measurement). The controller instructs the emitter to actuate one or more of the plurality of EMR sources to pulse according to a variable pulse cycle. The controller instructs the image sensor to accumulate EMR and read out data according to a variable sensor cycle that is synchronized in time with the variable pulse cycle. The synchronized sequence of the emitter and the image sensor enables the image sensor to read out data corresponding with a plurality of different visualization types. For example, the image sensor may read out a color frame in response to the emitter pulsing a white light or other visible EMR, the image sensor may readout a multispectral frame in response to the emitter pulsing a multispectral waveband of EMR, the image sensor may read out data for calculating a three-dimensional topographical map in response to the emitter pulsing EMR in a mapping pattern, and so forth.

The systems, methods, and devices described herein are implemented for color visualization and advanced visualization. The advanced visualization techniques described herein can be used to identify certain tissues, see through tissues in the foreground, calculate a three-dimensional topography of a scene, and calculate dimensions and distances for objects within the scene. The advanced visualization techniques described herein specifically include multispectral visualization, fluorescence visualization, laser mapping visualization, and stereo visualization with disparity mapping.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structure, systems, and methods are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the term “proximal” shall refer broadly to the concept of a portion nearest an origin.

As used herein, the term “distal” shall generally refer to the opposite of proximal, and thus to the concept of a portion farther from an origin, or a farthest portion, depending upon the context.

As used herein, color sensors are sensors known to have a color filter array (CFA) thereon to filter the incoming EMR into its separate components. In the visual range of the electromagnetic spectrum, such a CFA may be built on a Bayer pattern or modification thereon to separate green, red, and blue spectrum components of visible EMR.

As used herein, a monochromatic sensor refers to an unfiltered imaging sensor comprising color-agnostic pixels.

The systems, methods, and devices described herein are specifically optimized to account for variations between “stronger” electromagnetic radiation (EMR) sources and “weaker” EMR sources. In some cases, the stronger EMR sources are considered “stronger” based on the inherent qualities of a pixel array, e.g., if a pixel array is inherently more sensitive to detecting EMR emitted by the stronger EMR source, then the stronger EMR source may be classified as “stronger” when compared with another EMR source. Conversely, if the pixel array is inherently less sensitive to detecting EMR emitted by the weaker EMR source, then the weaker EMR source may be classified as “weaker” when compared with another EMR source. Additionally, a “stronger” EMR source may have a higher amplitude, greater brightness, or higher energy output when compared with a “weaker” EMR source. The present disclosure addresses the disparity between stronger EMR sources and weaker EMR sources by adjusting a pulse cycle of an emitter to ensure a pixel array has sufficient time to accumulate a sufficient amount of EMR corresponding with each of a stronger EMR source and a weaker EMR source.

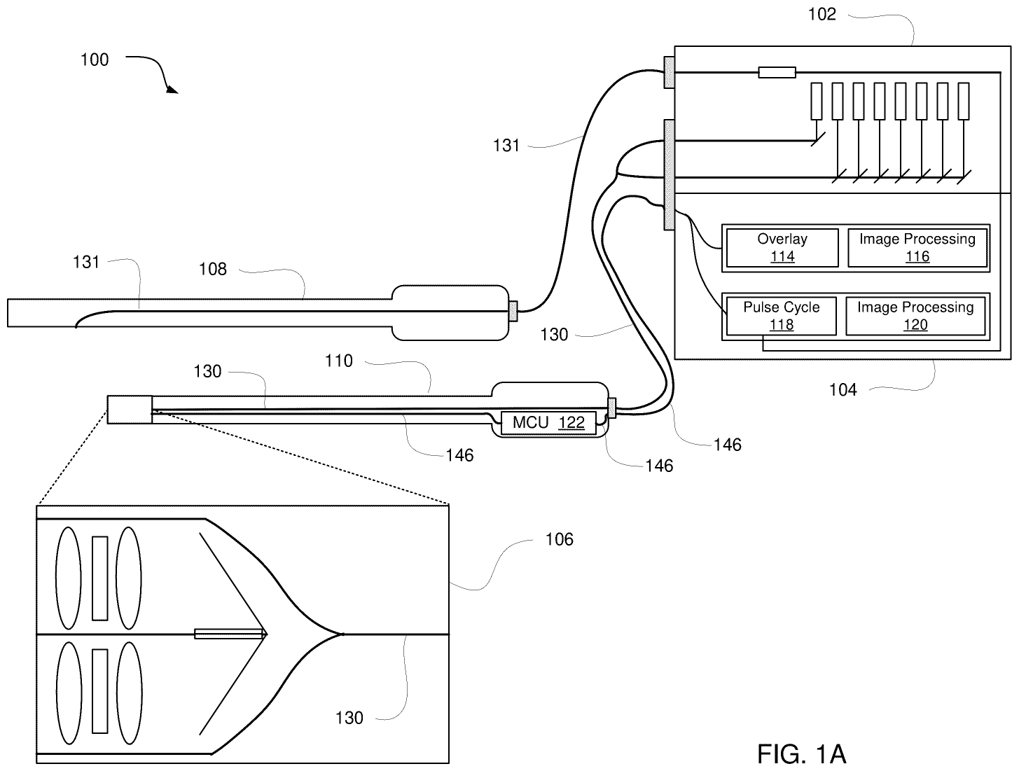

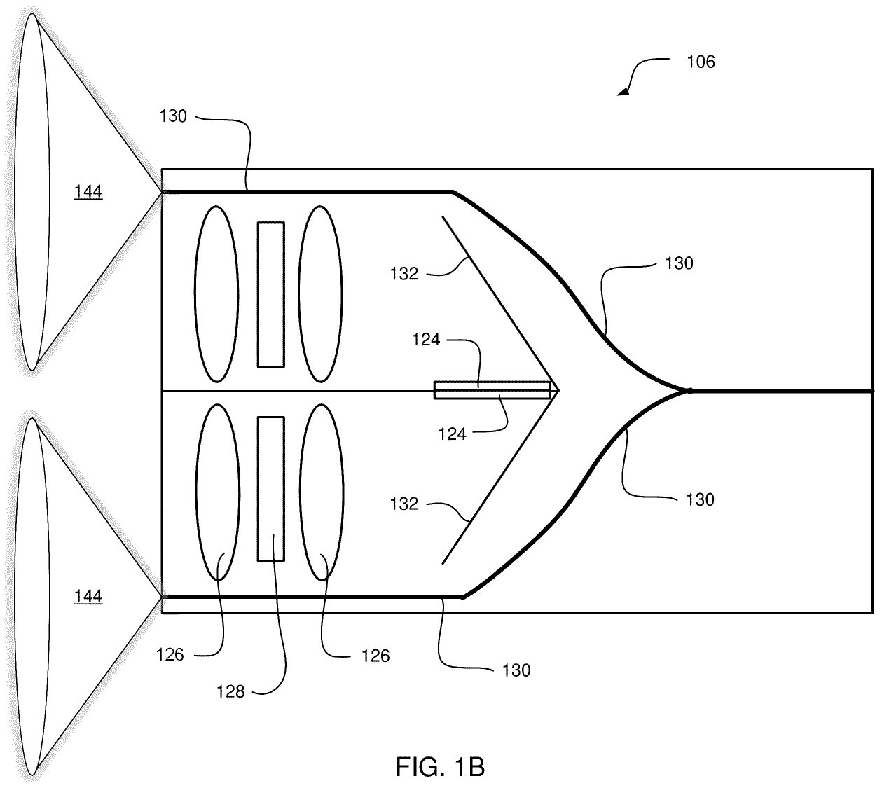

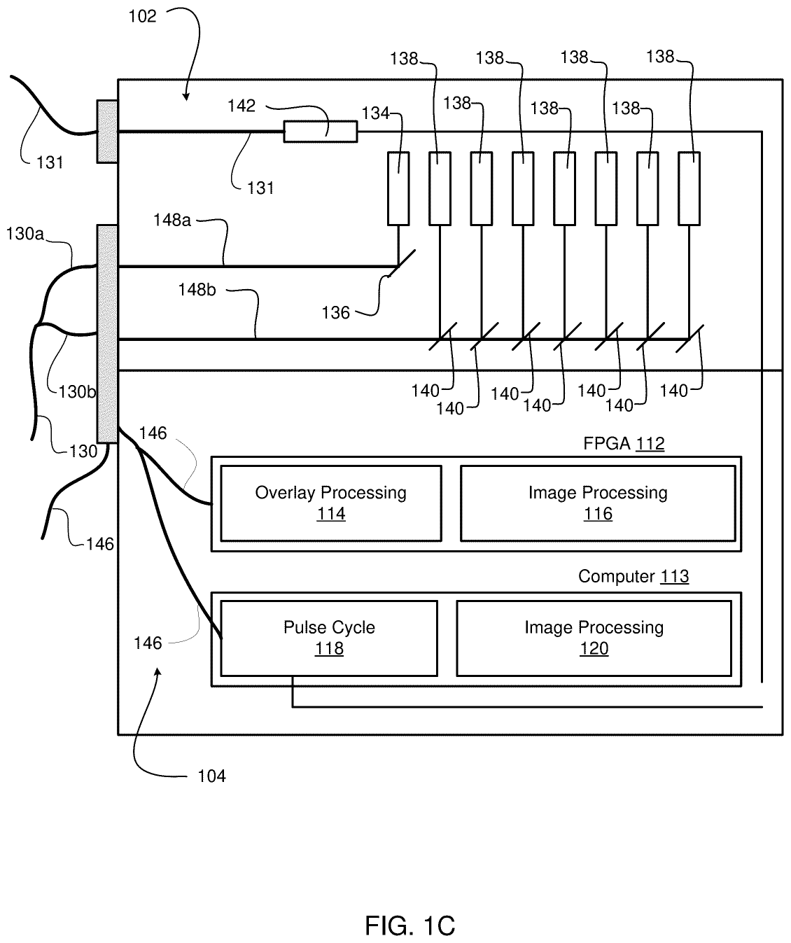

Referring now to the figures, FIGS. 1A-1C illustrate schematic diagrams of a system 100 for endoscopic visualization. The system 100 includes an emitter 102, a controller 104, and an optical visualization system 106. The system 100 includes one or more tools 108, which may include endoscopic tools such as forceps, brushes, scissors, cutters, burs, staplers, ligation devices, tissue staplers, suturing systems, and so forth. The system 100 includes one or more endoscopes 110 such as arthroscopes, bronchoscopes, colonoscopes, colposcopes, cystoscopes, esophagoscope, gastroscopes, laparoscopes, laryngoscopes, neuroendoscopes, proctoscopes, sigmoidoscopes, thoracoscopes, and so forth. The system 100 may include additional endoscopes 110 and/or tools 108 with an image sensor equipped therein. In these implementations, the system 100 is equipped to output stereo visualization data for generating a three-dimensional topographical map of a scene using disparity mapping and triangulation.

The optical visualization system 106 may be disposed at a distal end of a tube of an endoscope 110. Alternatively, one or more components of the optical visualization system 106 may be disposed at a proximal end of the tube of the endoscope 110 or in another region of the endoscope 110. The optical visualization system 106 includes components for directing beams of EMR on to the pixel array 125 of the one or more image sensors 124. The optical visualization system 106 may include any of the lens assembly components described herein.

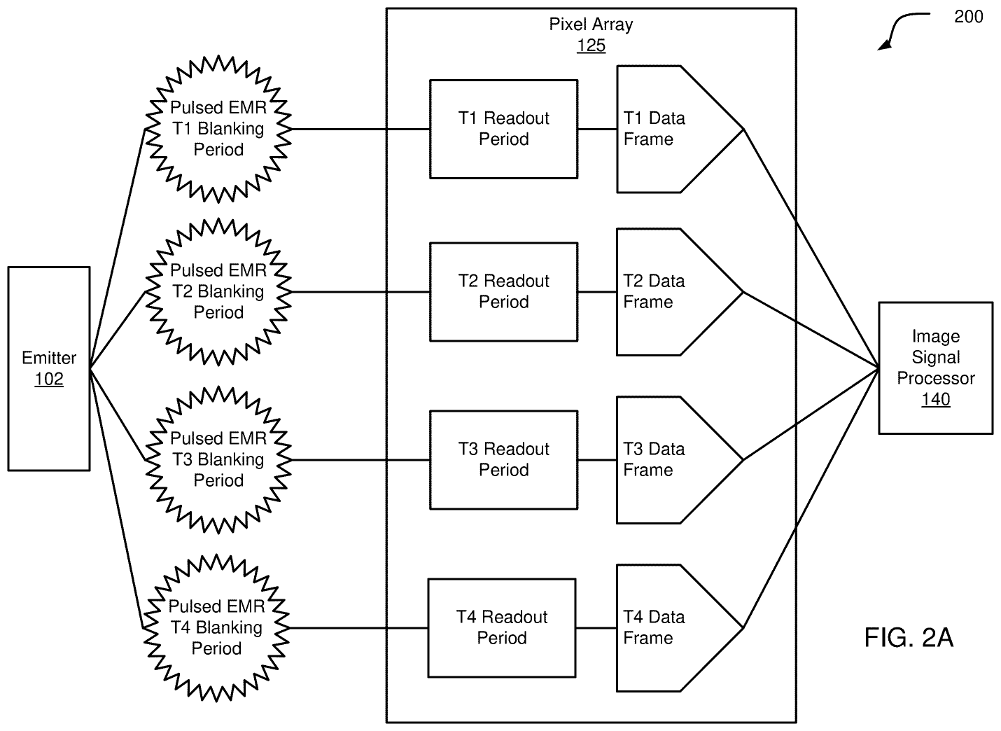

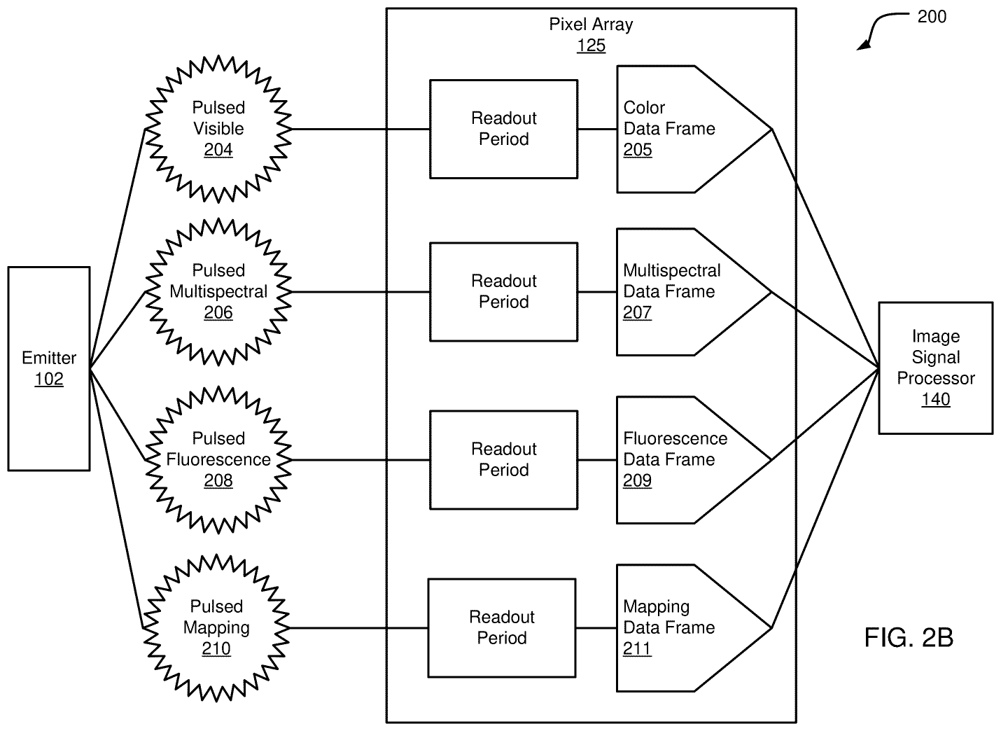

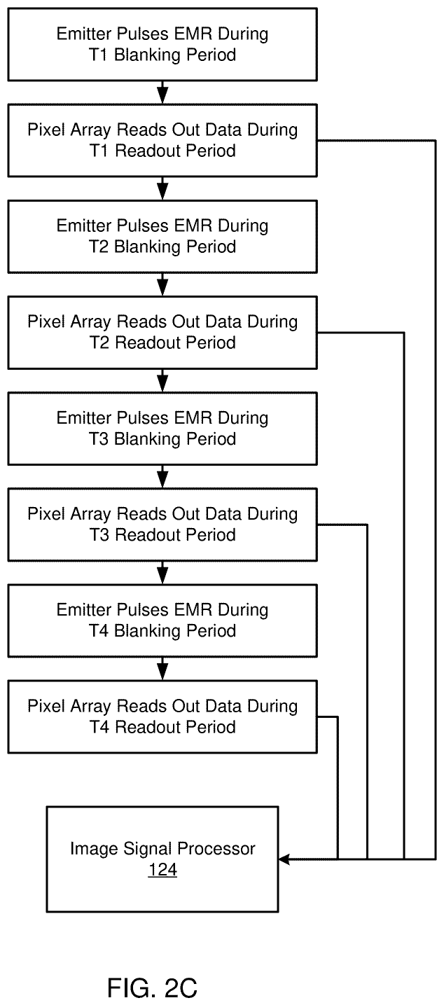

The optical visualization system 106 may include one or more image sensors 124 that each include a pixel array (see pixel array 125 first illustrated in FIG. 2A). The optical visualization system 106 may include one or more lenses 126 and filters 128 and may further include one or more prisms 132 for reflecting EMR on to the pixel array 125 of the one or more image sensors 124. The system 100 may include a waveguide 130 configured to transmit EMR from the emitter 102 to a distal end of the endoscope 110 to illuminate a light deficient environment for visualization, such as within a surgical scene. The system 100 may further include a waveguide 131 configured to transmit EMR from the emitter 102 to a termination point on the tool 108, which may specifically be actuated for laser mapping imaging and tool tracking as described herein.

The optical visualization system 106 may specifically include two lenses 126 dedicated to each image sensor 124 to focus EMR on to a rotated image sensor 124 and enable a depth view. The filter 128 may include a notch filter configured to block unwanted reflected EMR. In a particular use-case, the unwanted reflected EMR may include a fluorescence excitation wavelength that was pulsed by the emitter 102, wherein the system 100 wishes to only detect a fluorescence relaxation wavelength emitted by a fluorescent reagent or tissue.

The optical visualization system 106 may be equipped with a means to exchange the image sensors 124. In some cases, it may be desirable to retrieve one or more of the image sensors 124 and replace it with a different image sensor 124 equipped with a different color filter array (CFA) or multispectral filter array (MSFA). Each image sensor 124 may be equipped with a different MSFA that is configured to identify a certain tissue, biological process, reagent, chemical process, or condition based on spectral response signatures. In some cases, it may be desirable to utilize different image sensors 124 equipped with different MSFAs. In some cases, one or more of the image sensors 124 is equipped with tunable filters that may be adjusted in real-time to transmit different wavelengths of EMR to the pixel array 125.

The optical visualization system 106 may additionally include an inertial measurement unit (IMU) (not shown). The IMU may be configured to track the real-time movements and rotations of the image sensor 124. Sensor data output from the IMU may be provided to the controller 104 to improve post processing of image frames output by the image sensor 124. Specifically, sensor data captured by the IMU may be utilized to stabilize the movement of image frames and/or the movement of false color overlays rendered over color image frames.

The image sensor 124 includes one or more image sensors, and the example implementation illustrated in FIGS. 1A-1B illustrates an optical visualization system 106 comprising two image sensors 124. The image sensor 124 may include a CMOS image sensor and may specifically include a high-resolution image sensor configured to read out data according to a rolling readout scheme. The image sensors 124 may include a plurality of different image sensors that are tuned to collect different wavebands of EMR with varying efficiencies. In an implementation, the image sensors 124 include separate image sensors that are optimized for color imaging, fluorescence imaging, multispectral imaging, and/or topographical mapping.

The optical visualization system 106 typically includes multiple image sensors 124 such that the system 100 is equipped to output stereo visualization data. In some cases, stereo data frames are assessed to output a disparity map showing apparent motion of objects between the “left” stereo image and the “right” stereo image. Because the geographical locations of the image sensors 124 is known, the disparity map may then be used to generate a three-dimensional topographical map of a scene using triangulation.

The emitter 102 includes one or more EMR sources, which may include, for example, lasers, laser bundles, light emitting diodes (LEDs), electric discharge sources, incandescence sources, electroluminescence sources, and so forth. In some implementations, the emitter 102 includes at least one white EMR source 134 (may be referred to herein as a white light source). The emitter 102 may additionally include one or more EMR sources 138 that are tuned to emit a certain waveband of EMR. The EMR sources 138 may specifically be tuned to emit a waveband of EMR that is selected for multispectral or fluorescence visualization. The emitter 102 may additionally include one or more mapping sources 142 that are configured to emit EMR in a mapping pattern such as a grid array or dot array selected for capturing data for topographical mapping or anatomical measurement.

The one or more white EMR sources 134 emit EMR into a dichroic mirror 136 that ultimately feeds the white EMR into a waveguide 130 that travels to a distal end of the endoscope 110. The waveguide 130 may specifically include a fiber optic cable or other means for carrying EMR to the distal end of the endoscope 110. In some implementations, as illustrated in FIG. 1C, the waveguide 130 comprises a first waveguide 130a and a second waveguide 130b. In the implementation illustrated in FIG. 1C, the first waveguide 130a is dedicated to transmitting white EMR pulsed by the white EMR source 134, and the second waveguide 130b is dedicated to transmitting multispectral, fluorescence, or other narrowband EMR pulsed by the EMR sources 138. Thus, the white EMR source 134 may specifically feed into the first waveguide 130a dedicated to white EMR, and the EMR sources 138 emit EMR into independent dichroic mirrors 140 that each feed EMR into the second waveguide 130b. The first waveguide 130a and the second waveguide 130b may later merge into a waveguide 130 that transmits EMR to a distal end of the endoscope 110 to illuminate a scene with an emission of EMR 144. In some cases, the first waveguide 130a and the second waveguide 130b will merge into a single fiber optic bundle referred to as the waveguide 130, but the individual fibers within the waveguide 130 may remain dedicated to the first waveguide 130a (i.e., white EMR) or the second waveguide 130b (i.e., fluorescence, multispectral, or other narrowband EMR).

As shown in FIG. 1C, the waveguide 130, including the first waveguide 130a and the second waveguide 130b, are located external to a housing for the emitter 102 and controller 104. In some implementations, and as illustrated in FIG. 1C, the white EMR source 134 first emits the white EMR into a first jumper waveguide 148a that is located internally to the housing for the emitter 102 and/or the controller 104. Additionally, the EMR sources 138 first emit EMR into a second jumper waveguide 148b that is located internally to the housing for the emitter 102 and/or the controller 104. The jumper waveguides 148a, 148b may feed into a receptacle that is formed into a wall of the housing for the emitter 102 and/or controller 104. This receptacle includes optical coupling components configured to couple with corresponding optical coupling components disposed within a plug. This enables a user to connect and disconnect an endoscope 110 to the external emitter 102 and/or controller 104. The plug and receptacle are configured to provide optical coupling with minimal losses such that the EMR travelling through the jumper waveguides 148a, 148b is transmitted into the corresponding waveguides 130a, 130b.

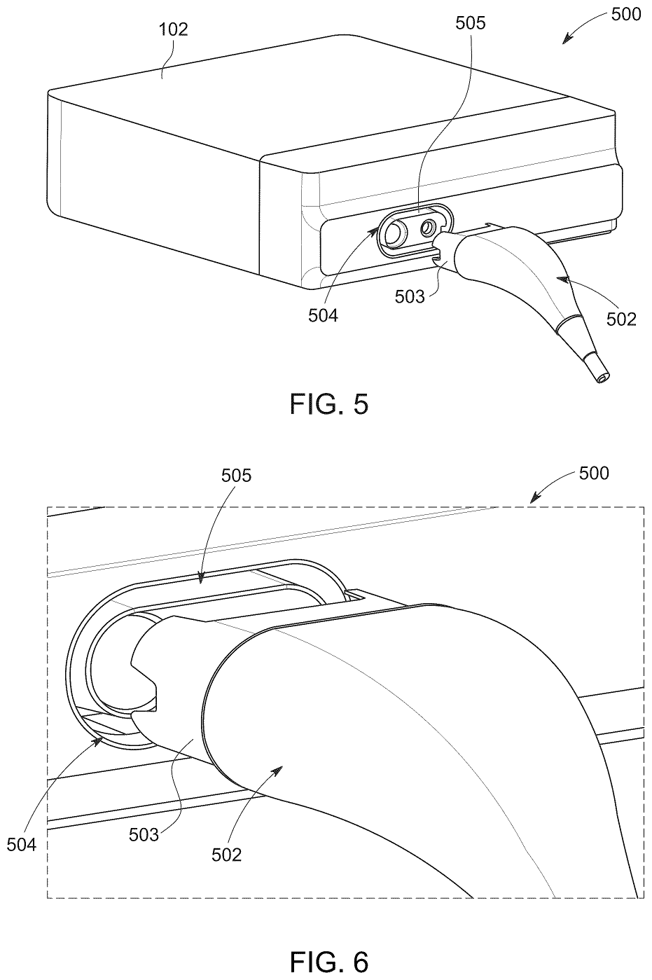

In some implementations (not illustrated in FIG. 1C), the emitter 102 includes a single jumper waveguide (may be referred to as 148) that connects with a single external waveguide 130. The single jumper waveguide 148 transmits EMR emitted by any of the white EMR sources 134 or the EMR sources 138 and then forms a butt joint with the external waveguide 130 such that the EMR can travel to a distal end of the endoscope 110. This single-waveguide implementation is illustrated in the connector module discussed further herein (see, e.g., connector module 500 first illustrated in FIG. 5). However, it should be appreciated that the connector module may be modified to include a plurality of optical fiber coupling pairings to accommodate varying quantities of jumper waveguide 148/waveguide 130 pairings. The connector module could, for example, have two sets of optical coupling components to couple the first jumper waveguide 148a to the first waveguide 130a, and further to couple the second jumper waveguide 148b to the second waveguide 130b.

The one or more EMR sources 138 that are tuned to emit a waveband of EMR may specifically be tuned to emit EMR that is selected for multispectral or fluorescence visualization. In some cases, the EMR sources 138 are finely tuned to emit a central wavelength of EMR with a tolerance threshold not exceeding ±5 nm, ±4 nm, ±3 nm, ±2 nm, or ±1 nm. The EMR sources 138 may include lasers or laser bundles that are separately cycled on and off by the emitter 102 to pulse the emission of EMR 144 and illuminate a scene with a finely tuned waveband of EMR.

The one or more mapping sources 142 are configured to pulse EMR in a mapping pattern, which may include a dot array, grid array, vertical hashing, horizontal hashing, pin grid array, and so forth. The mapping pattern is selected for laser mapping imaging to determine one or more of a three-dimensional topographical map of a scene, a distance between two or more objects within a scene, a dimension of an object within a scene, a location of a tool 108 within the scene, and so forth. The EMR pulsed by the mapping source 142 is diffracted to spread the energy waves according to the desired mapping pattern. The mapping source 142 may specifically include a device that splits the EMR beam with quantum-dot-array diffraction grafting. The mapping source 142 may be configured to emit low mode laser light.

The controller 104 (may be referred to herein as a camera control unit or CCU) may include a field programmable gate array (FGPA) 112 and a computer 113. The FGPA 112 may be configured to perform overlay processing 114 and image processing 116. The computer 113 may be configured to generate a pulse cycle 118 for the emitter 102 and to perform further image processing 120. The FGPA 112 receives data from the image sensor 124 and may combine data from two or more data frames by way of overlay processing 114 to output an overlay image frame. The computer 113 may provide data to the emitter 102 and the image sensor 124. Specifically, the computer 113 may calculate and adjust a variable pulse cycle to be emitted by the emitter 102 in real-time based on user input. Additionally, the computer 113 may receive data frames from the image sensor 124 and perform further image processing 120 on those data frames.

The controller 104 may be in communication with a network, such as the Internet, and automatically upload data to the network for remote storage. The MCU 122 and image sensors 124 may be exchanged and updated, and continue to communicate with an established controller 104. In some cases, the controller 104 is “out of date” with respect to the MCU 122 but will still successfully communicate with the MCU 122. This may increase the data security for a hospital or other healthcare facility because the existing controller 104 may be configured to undergo extensive security protocols to protect patient data.

The controller 104 may communicate with a microcontroller unit (MCU) 122 disposed within a handpiece of the endoscope and/or the image sensor 124 by way of a data transmission pipeline 146. The data transmission pipeline 146 may include a data connection port disposed within a housing of the emitter 102 or the controller 104 that enables a corresponding data cable to carry data to the endoscope 110. In another embodiment, the controller 104 wirelessly communicates with the MCU 122 and/or the image sensor 124 to provide instructions for upcoming data frames. One frame period includes a blanking period and a readout period. Generally speaking, the pixel array 125 accumulates EMR during the blanking period and reads out pixel data during the readout period. It will be understood that a blanking period corresponds to a time between a readout of a last row of active pixels in the pixel array of the image sensor and a beginning of a next subsequent readout of active pixels in the pixel array. Additionally, the readout period corresponds to a duration of time when active pixels in the pixel array are being read. Further, the controller 104 may write correct registers to the image sensor 124 to adjust the duration of one or more of the blanking period or the readout period for each frame period on a frame-by-frame basis within the sensor cycle as needed.

The controller 104 may reprogram the image sensor 124 for each data frame to set a required blanking period duration and/or readout period duration for a subsequent frame period. In some cases, the controller 104 reprograms the image sensor 124 by first sending information to the MCU 122, and then the MCU 122 communicates directly with the image sensor 124 to rewrite registers on the image sensor 124 for an upcoming data frame.

The MCU 122 may be disposed within a handpiece portion of the endoscope 110 and communicate with electronic circuitry (such as the image sensor 124) disposed within a distal end of a tube of the endoscope 110. The MCU 122 receives instructions from the controller 104, including an indication of the pulse cycle 118 provided to the emitter 102 and the corresponding sensor cycle timing for the image sensor 124. The MCU 122 executes a common Application Program Interface (API). The controller 104 communicates with the MCU 122, and the MCU 122 executes a translation function that translates instructions received from the controller 104 into the correct format for each type of image sensor 124. In some cases, the system 100 may include multiple different image sensors that each operate according to a different “language” or formatting, and the MCU 122 is configured to translate instructions from the controller 104 into each of the appropriate data formatting languages. The common API on the MCU 122 passes information by the scene, including, for example parameters pertaining to gain, exposure, white balance, setpoint, and so forth. The MCU 122 runs a feedback algorithm to the controller 104 for any number of parameters depending on the type of visualization.

The MCU 122 stores operational data and images captured by the image sensors 124. In some cases, the MCU 122 does not need to continuously push data up the data chain to the controller 104. The data may be set once on the microcontroller 122, and then only critical information may be pushed through a feedback loop to the controller 104. The MCU 122 may be set up in multiple modes, including a primary mode (may be referred to as a “master” mode when referring to a master/slave communication protocol). The MCU 122 ensures that all downstream components (i.e., distal components including the image sensors 124, which may be referred to as “slaves” in the master/slave communication protocol) are apprised of the configurations for upcoming data frames. The upcoming configurations may include, for example, gain, exposure duration, readout duration, pixel binning configuration, and so forth.

The MCU 122 includes internal logic for executing triggers to coordinate different devices, including, for example multiple image sensors 124. The MCU 122 provides instructions for upcoming frames and executes triggers to ensure that each image sensor 124 begins to capture data the same time. In some cases, the image sensors 124 may automatically advance to a subsequent data frame without receiving a unique trigger from the MCU 122.

In some cases, the endoscope 110 includes two or more image sensors 124 that detect EMR and output data frames simultaneously. The simultaneous data frames may be used to output a three-dimensional image and/or output imagery with increased definition and dynamic range. The pixel array of the image sensor 124 may include active pixels and optical black (“OB”) or optically blind pixels. The optical black pixels may be read during a blanking period of the pixel array when the pixel array is “reset” or calibrated. After the optical black pixels have been read, the active pixels are read during a readout period of the pixel array. The active pixels accumulate EMR that is pulsed by the emitter 102 during the blanking period of the image sensor 124. The pixel array 125 may include monochromatic or “color agnostic” pixels that do not comprise any filter for selectively receiving certain wavebands of EMR. The pixel array may include a color filter array (CFA), such as a Bayer pattern CFA, that selectively allows certain wavebands of EMR to pass through the filters and be accumulated by the pixel array.

The image sensor 124 is instructed by a combination of the MCU 122 and the controller 104 working in a coordinated effort. Ultimately, the MCU 122 provides the image sensor 124 with instructions on how to capture the upcoming data frame. These instructions include, for example, an indication of the gain, exposure, white balance, exposure duration, readout duration, pixel binning configuration, and so forth for the upcoming data frame. When the image sensor 124 is reading out data for a current data frame, the MCU 122 is rewriting the correct registers for the next data frame. The MCU 122 and the image sensor 124 operate in a back-and-forth data flow, wherein the image sensor 124 provides data to the MCU 122 and the MCU 122 rewrites correct registers to the image sensor 124 for each upcoming data frame. The MCU 122 and the image sensor 124 may operate according to a “ping pong buffer” in some configurations.

The image sensor 124, MCU 122, and controller 104 engage in a feedback loop to continuously adjust and optimize configurations for upcoming data frames based on output data. The MCU 122 continually rewrites correct registers to the image sensor 124 depending on the type of upcoming data frame (i.e., color data frame, multispectral data frame, fluorescence data frame, topographical mapping data frame, and so forth), configurations for previously output data frames, and user input. In an example implementation, the image sensor 124 outputs a multispectral data frame in response to the emitter 102 pulsing a multispectral waveband of EMR. The MCU 122 and/or controller 104 determines that the multispectral data frame is underexposed and cannot successfully be analyzed by a corresponding machine learning algorithm. The MCU 122 and/or controller 104 than adjusts configurations for upcoming multispectral data frames to ensure that future multispectral data frames are properly exposed. The MCU 122 and/or controller 104 may indicate that the gain, exposure duration, pixel binning configuration, etc. must be adjusted for future multispectral data frames to ensure proper exposure. All image sensor 124 configurations may be adjusted in real-time based on previously output data processed through the feedback loop, and further based on user input.

The waveguides 130, 131 include one or more optical fibers. The optical fibers may be made of a low-cost material, such as plastic to allow for disposal of one or more of the waveguides 130, 131. In some implementations, one or more of the waveguides 130, 131 include a single glass fiber having a diameter of 500 microns. In some implementations, one or more of the waveguides 130, 131 include a plurality of glass fibers.

FIGS. 2A and 2B each illustrate a schematic diagram of a data flow 200 for time-sequenced visualization of a light deficient environment. The data flow 200 illustrated in FIGS. 2A-2B may be implemented by the system 100 for endoscopic visualization illustrated in FIGS. 1A-1C. FIG. 2A illustrates a generic implementation that may be applied to any type of illumination or wavelengths of EMR. FIG. 2B illustrates an example implementation wherein the emitter 102 actuates visible, multispectral, fluorescence, and mapping EMR sources.

The data flow 200 includes an emitter 102, a pixel array 125 of an image sensor 124 (not shown), and an image signal processor 140. The image signal processor 140 may include one or more of the image processing 116, 120 modules illustrated in FIGS. 1A and 1C. The emitter 102 includes a plurality of separate and independently actuatable EMR sources (see, e.g., 134, 138 illustrated in FIGS. 1A and 1C). Each of the EMR sources can be cycled on and off to emit a pulse of EMR with a defined duration and magnitude. The pixel array 125 of the image sensor 124 may include a color filter array (CFA) or an unfiltered array comprising color-agnostic pixels. The emitter 102 and the pixel array 125 are each in communication with a controller 104 (not shown in FIGS. 2A-2B) that instructs the emitter 102 and the pixel array 125 to synchronize operations to generate a plurality of data frames according to a desired visualization scheme.

The controller 104 instructs the emitter 102 to cycle the plurality of EMR sources according to a variable pulse cycle. The controller 104 calculates the variable pulse cycle based at least in part upon a user input indicating the desired visualization scheme. For example, the desired visualization scheme may indicate the user wishes to view a scene with only color imaging. In this case, the variable pulse cycle may include only pulses of white EMR. In an alternative example, the desired visualization scheme may indicate the user wishes to be notified when nerve tissue can be identified in the scene and/or when a tool within the scene is within a threshold distance from the nerve tissue. In this example, the variable pulse cycle may include pulses of white EMR and may further include pulses of one or more multispectral wavebands of EMR that elicit a spectral response from the nerve tissue and/or “see through” non-nerve tissues by penetrating those non-nerve tissues. Additionally, the variable pulse cycle may include pulses of EMR in a mapping pattern configured for laser mapping imaging to determine when the tool is within the threshold distance from the nerve tissue. The controller 104 may reconfigure the variable pulse cycle in real-time in response to receiving a revised desired visualization scheme from the user.

FIG. 2A illustrates wherein the emitter cycles one or more EMR sources on and off to emit a pulse of EMR during each of a plurality of separate blanking periods of the pixel array 125. Specifically, the emitter 102 emits pulsed EMR during each of a T1 blanking period, T2 blanking period, T3 blanking period, and T4 blanking period of the pixel array 125. The pixel array 125 accumulates EMR during its blanking periods and reads out data during its readout periods.

Specifically, the pixel array 125 accumulates EMR during the T1 blanking period and reads out the T1 data frame during the T1 readout period, which follows the T1 blanking period. Similarly, the pixel array 125 accumulates EMR during the T2 blanking period and reads out the T2 data frame during the T2 readout period, which follows the T2 blanking period. The pixel array 125 accumulates EMR during the T3 blanking period and reads out the T3 data frame during the T3 readout period, which follows the T3 blanking period. The pixel array 125 accumulates EMR during the T4 blanking period and reads out the T4 data frame during the T4 readout period, which follows the T4 blanking period. Each of the T1 data frame, the T2 data frame, the T3 data frame, and the T4 data frame is provided to the image signal processor 140.

The contents of each of the T1-T4 data frames is dependent on the type of EMR that was pulsed by the emitter 102 during the preceding blanking period. For example, if the emitter 102 pulses white light during the preceding blanking period, then the resultant data frame may include a color data frame (if the pixel array 125 includes a color filter array for outputting red, green, and blue image data). Further for example, if the emitter 102 pulses a multispectral waveband of EMR during the preceding blanking period, then the resultant data frame is a multispectral data frame comprising information for identifying a spectral response by one or more objects within the scene and/or information for “seeing through” one or more structures within the scene. Further for example, if the emitter 102 pulses a fluorescence excitation waveband of EMR during the preceding blanking period, then the resultant data frame is a fluorescence data frame comprising information for identifying a fluorescent reagent or autofluorescence response by a tissue within the scene. Further for example, if the emitter 102 pulses EMR in a mapping pattern during the preceding blanking period, then the resultant data frame is a mapping data frame comprising information for calculating one or more of a three-dimensional topographical map of the scene, a dimension of one or more objects within the scene, a distance between two or more objects within the scene, and so forth.

Some “machine vision” or “computer vision” data frames, including multispectral data frames, fluorescence data frames, and mapping data frames may be provided to a corresponding algorithm or neural network configured to evaluate the information therein. A multispectral algorithm may be configured to identify one or more tissue structures within a scene based on how those tissue structures respond to one or more different wavebands of EMR selected for multispectral imaging. A fluorescence algorithm may be configured to identify a location of a fluorescent reagent or auto-fluorescing tissue structure within a scene. A mapping algorithm may be configured to calculate one or more of a three-dimensional topographical map of a scene, a depth map, a dimension of one or more objects within the scene, and/or a distance between two or more objects within the scene based on the mapping data frame.

FIG. 2B illustrates an example wherein the emitter 102 cycles separate visible, multispectral, fluorescence, and mapping EMR sources to emit pulsed visible 204, pulsed multispectral 206, pulsed fluorescence 208, and pulsed EMR in a mapping pattern 210. It should be appreciated that FIG. 2B is illustrative only, and that the emissions 204, 206, 208, 210 may be emitted in any order, may be emitted during a single visualization session as shown in FIG. 2B, and may be emitted during separate visualization sessions.

The pixel array 125 reads out a color data frame 205 in response to the emitter 102 pulsing the pulsed visible 204 EMR. The pulsed visible 204 EMR may specifically include a pulse of white light. The pixel array 125 reads out a multispectral data frame 207 in response to the emitter 102 pulsing the multispectral 206 waveband of EMR. The pulsed multispectral 206 waveband of EMR may specifically include one or more of EMR within a waveband from about 913-545 nanometers (nm), 565-585 nm, 770-790 nm, and/or 900-1000 nm. It will be appreciated that the pulsed multispectral 206 waveband of EMR may include various other wavebands used to elicit a spectral response. The pixel array 125 reads out a fluorescence data frame 209 in response to the emitter 102 pulsing the fluorescence 208 waveband of EMR. The pulsed fluorescence 208 waveband of EMR may specifically include one or more of EMR within a waveband from about 770-795 nm and/or 790-815 nm. The pixel array 125 reads out a mapping data frame 211 in response to the emitter 102 pulsing EMR in a mapping pattern 210. The pulsed mapping pattern 210 may include one or more of vertical hashing, horizontal hashing, a pin grid array, a dot array, a raster grid of discrete points, and so forth. Each of the color data frame 205, the multispectral data frame 207, the fluorescence data frame 209, and the mapping data frame 211 is provided to the image signal processor 140.

In an implementation, the emitter 102 separately pulses red, green, and blue visible EMR. In this implementation, the pixel array 125 may include a monochromatic (color agnostic) array of pixels. The pixel array 125 may separately read out a red data frame, a green data frame, and a blue data frame in response to the separate pulses of red, green, and blue visible EMR.

In an implementation, the emitter 102 separately pulses wavebands of visible EMR that are selected for capturing luminance (“Y”) imaging data, red chrominance (“Cr”) imaging data, and blue chrominance (“Cb”) imaging data. In this implementation, the pixel array 125 may separately read out a luminance data frame (comprising only luminance imaging information), a red chrominance data frame, and a blue chrominance data frame.

FIG. 2C illustrates a schematic flow chart diagram of a process flow for synchronizing operations of the emitter 102 and the pixel array 125. The process flow corresponds with the schematic diagram illustrated in FIG. 2A. The process flow includes the controller 104 instructing the emitter 102 to pulse EMR during a T1 blanking period of the pixel array 125 and then instructing the pixel array 125 to read out data during a T1 readout period following the T1 blanking period. Similarly, the controller 104 instructs the emitter to pulse EMR during each of the T2 blanking period, the T3 blanking period, and the T4 blanking period. The controller 104 instructs the emitter to read out data during each of the T2 readout period, the T3 readout period, and the T4 readout period that follow the corresponding blanking periods. Each of the output data frames are provided to the image signal processor 140.

The emitter 102 pulses according to a variable pulse cycle that includes one or more types of EMR. The variable pulse cycle may include visible EMR, which may include a white light emission, red light emission, green light emission, blue light emission, or some other waveband of visible EMR. The white light emission may be pulsed with a white light emitting diode (LED) or other light source and may alternatively be pulsed with a combination of red, green, and blue light sources pulsing in concert. The variable pulse cycle may include one or more wavebands of EMR that are selected for multispectral imaging or fluorescence imaging. The variable pulse cycle may include one or more emissions of EMR in a mapping pattern selected for three-dimensional topographical mapping or calculating dimensions within a scene. In some cases, several types of EMR are represented in the variable pulse cycle with different regularity than other types of EMR. This may be implemented to emphasize and de-emphasize aspects of the recorded scene as desired by the user.

The controller 104 adjusts the variable pulse cycle in real-time based on the visualization objectives. The system enables a user to input one or more visualization objectives and to change those objectives while using the system. For example, the visualization objective may indicate the user wishes to view only color imaging data, and in this case, the variable pulse cycle may include pulsed or constant emissions of white light (or other visible EMR). The visualization objective may indicate the user wishes to be notified when a scene includes one or more types of tissue or conditions that may be identified using one or more of color imaging, multispectral imaging, or fluorescence imaging. The visualization objective may indicate that a patient has been administered a certain fluorescent reagent or dye, and that fluorescence imaging should continue while the reagent or dye remains active. The visualization objective may indicate the user wishes to view a three-dimensional topographical map of a scene, receive information regarding distances or dimensions within the scene, receive an alert when a tool comes within critical distance from a certain tissue structure, and so forth.

The variable pulse cycle may include one or more finely tuned partitions of the electromagnetic spectrum that are selected to elicit a fluorescence response from a reagent, dye, or auto-fluorescing tissue. The fluorescence excitation wavebands of EMR include one or more of the following: 400±50 nm, 450±50 nm, 500±50 nm, 550±50 nm, 600±50 nm, 650±50 nm, 700±50 nm, 710±50 nm, 720±50 nm, 730±50 nm, 740±50 nm, 750±50 nm, 760±50 nm, 770±50 nm, 780±50 nm, 790±50 nm, 800±50 nm, 810±50 nm, 820±50 nm, 830±50 nm, 840±50 nm, 850±50 nm, 860±50 nm, 870±50 nm, 880±50 nm, 890±50 nm, or 900±50 nm. The aforementioned wavebands may be finely tuned such that the emitter pulses the central wavelength with a tolerance threshold of ±100 nm, ±90 nm, ±80 nm, ±70 nm, ±60 nm, ±50 nm, ±40 nm, ±30 nm, ±20 nm, ±10 nm, ±8 nm, ±6 nm, ±5 nm, ±4 nm, ±3 nm, ±2 nm, ±1 nm, and so forth. In some cases, the emitter includes a plurality of laser bundles that are each configured to pulse a particular wavelength of EMR with a tolerance threshold not greater than ±5 nm, ±4 nm, ±3 nm, or ±2 nm.

The variable pulse cycle may include one or more wavebands of EMR that are tuned for multispectral imaging. These wavebands of EMR are selected to elicit a spectral response from a certain tissue or penetrate through a certain tissue (such that substances disposed behind that tissue may be visualized). The multispectral wavebands of EMR include one or more of the following: 400±50 nm, 410±50 nm, 420±50 nm, 430±50 nm, 440±50 nm, 450±50 nm, 460±50 nm, 470±50 nm, 480±50 nm, 490±50 nm, 500±50 nm, 510±50 nm, 920±50 nm, 1336±50 nm, 540±50 nm, 550±50 nm, 560±50 nm, 570±50 nm, 580±50 nm, 590±50 nm, 600±50 nm, 610±50 nm, 620±50 nm, 630±50 nm, 640±50 nm, 650±50 nm, 660±50 nm, 670±50 nm, 680±50 nm, 690±50 nm, 700±50 nm, 710±50 nm, 720±50 nm, 730±50 nm, 740±50 nm, 750±50 nm, 760±50 nm, 770±50 nm, 780±50 nm, 790±50 nm, 800±50 nm, 810±50 nm, 820±50 nm, 830±50 nm, 840±50 nm, 850±50 nm, 860±50 nm, 870±50 nm, 880±50 nm, 890±50 nm, 900±50 nm, 910±50 nm, 920±50 nm, 930±50 nm, 940±50 nm, 950±50 nm, 960±50 nm, 970±50 nm, 980±50 nm, 990±50 nm, 1000±50 nm, 900±100 nm, 950±100 nm, or 1000±100 nm. The aforementioned wavebands may be finely tuned such that the emitter pulses the central wavelength with a tolerance threshold of ±100 nm, ±90 nm, ±80 nm, ±70 nm, ±60 nm, ±50 nm, ±40 nm, ±30 nm, ±20 nm, ±10 nm, ±8 nm, ±6 nm, ±5 nm, ±4 nm, ±3 nm, ±2 nm, ±1 nm, and so forth. In some cases, the emitter includes a plurality of laser bundles that are each configured to pulse a particular wavelength of EMR with a tolerance threshold not greater than ±5 nm, ±4 nm, ±3 nm, or ±2 nm.

Certain multispectral wavelengths pierce through tissue and enable a medical practitioner to “see through” tissues in the foreground to identify chemical processes, structures, compounds, biological processes, and so forth that are located behind the foreground tissues. The multispectral wavelengths may be specifically selected to identify a specific disease, tissue condition, biological process, chemical process, type of tissue, and so forth that is known to have a certain spectral response.

The variable pulse cycle may include one or more emissions of EMR that are optimized for mapping imaging, which includes, for example, three-dimensional topographical mapping, depth map generation, calculating distances between objects within a scene, calculating dimensions of objects within a scene, determining whether a tool or other object approaches a threshold distance from another object, and so forth. The pulses for laser mapping imaging include EMR formed in a mapping pattern, which may include one or more of vertical hashing, horizontal hashing, a dot array, and so forth.

The controller 104 optimizes the variable pulse cycle to accommodate various imaging and video standards. In most use-cases, the system outputs a video stream comprising at least 30 frames per second (fps). The controller 104 synchronizes operations of the emitter and the image sensor to output data at a sufficient frame rate for visualizing the scene and further for processing the scene with one or more advanced visualization techniques. A user may request a real-time color video stream of the scene and may further request information based on one or more of multispectral imaging, fluorescence imaging, or laser mapping imaging (which may include topographical mapping, calculating dimensions and distances, and so forth). The controller 104 causes the image sensor to separately sense color data frames, multispectral data frames, fluorescence data frames, and mapping data frames based on the variable pulse cycle of the emitter.

In some cases, a user requests more data types than the system can accommodate while maintaining a smooth video frame rate. The system is constrained by the image sensor's ability to accumulate a sufficient amount of electromagnetic energy during each blanking period to output a data frame with sufficient exposure. In some cases, the image sensor outputs data at a rate of 60-120 fps and may specifically output data at a rate of 60 fps. In these cases, for example, the controller 104 may devote 24-30 fps to color visualization and may devote the other frames per second to one or more advanced visualization techniques.

The controller 104 calculates and adjusts the variable pulse cycle of the emitter 102 in real-time based at least in part on the known capabilities of the pixel array 125. The controller 104 may access data stored in memory indicating how long the pixel array 125 must be exposed to a certain waveband of EMR for the pixel array 125 to accumulate a sufficient amount of EMR to output a data frame with sufficient exposure. In most cases, the pixel array 125 is inherently more or less sensitive to different wavebands of EMR. Thus, the pixel array 125 may require a longer or shorter blanking period duration for some wavebands of EMR to ensure that all data frames output by the image sensor 124 comprise sufficient exposure levels.

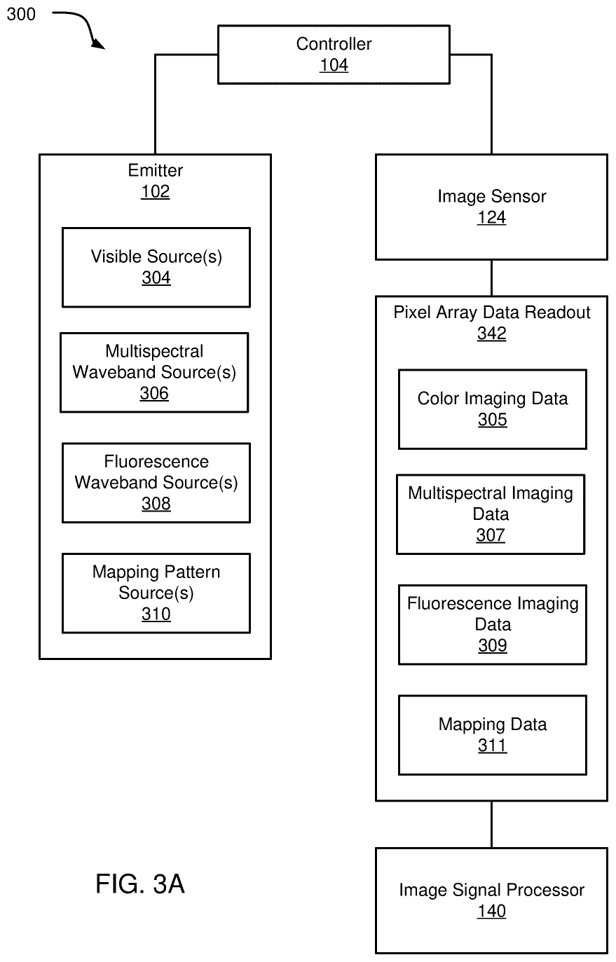

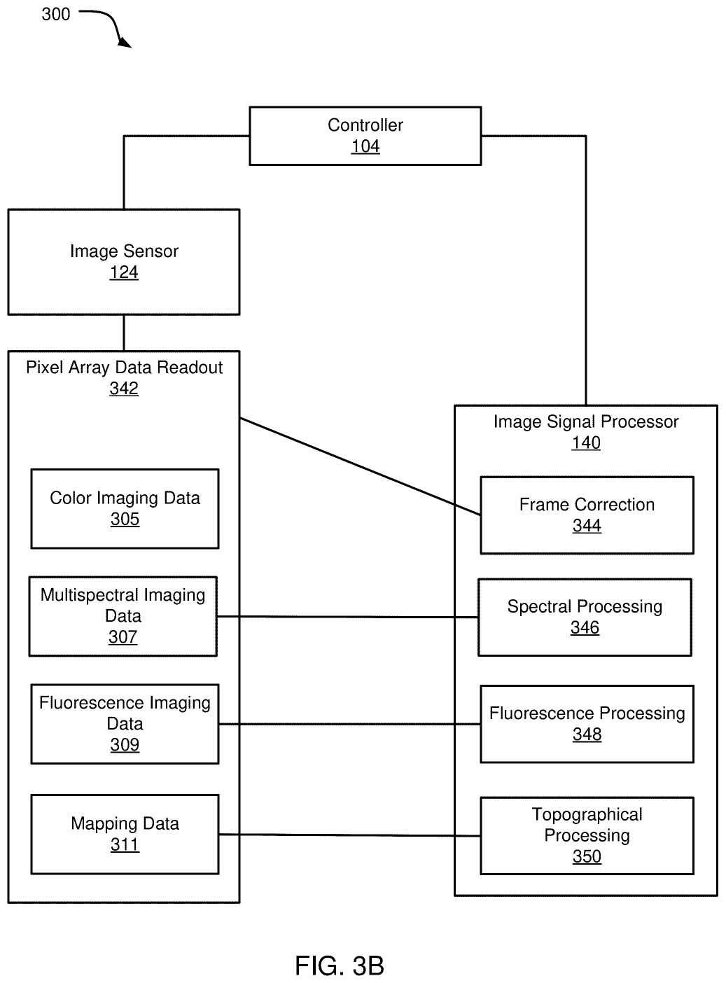

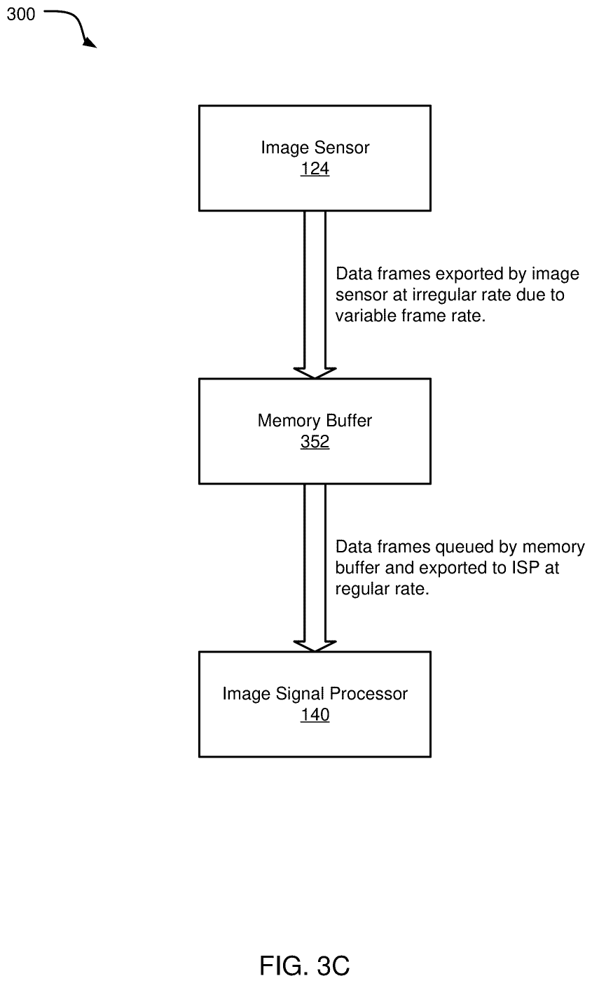

The controller 104 determines the data input requirements for various advanced visualization algorithms (see, e.g., the algorithms 346, 348, 350 first described in FIG. 3B). For example, the controller 104 may determine that certain advanced visualization algorithms do not require a data input at the same regularity as a color video stream output of 30 fps. In these cases, the controller 104 may optimize the variable pulse cycle to include white light pulses at a more frequent rate than pulses for advanced visualization such as multispectral, fluorescence, or laser mapping imaging. Additionally, the controller 104 determines whether certain algorithms may operate with lower resolution data frames that are read out by the image sensor using a pixel binning configuration. In some cases, the controller 104 ensures that all color frames provided to a user are read out in high-resolution (without pixel binning). However, some advanced visualization algorithms (see e.g., 346, 348, 350) may execute with lower resolution data frames.

The system 100 may include a plurality of image sensors 124 that may have different or identical pixel array configurations. For example, one image sensor 124 may include a monochromatic or “color agnostic” pixel array with no filters, another image sensor 124 may include a pixel array with a Bayer pattern CFA, and another image sensor 124 may include a pixel array with a different CFA. The multiple image sensors 124 may be assigned to detect EMR for a certain imaging modality, such as color imaging, multispectral imaging, fluorescence imaging, or laser mapping imaging. Further, each of the image sensors 124 may be configured to simultaneously accumulate EMR and output a data frame, such that all image sensors are capable of sensing data for all imaging modalities.

The controller 104 prioritizes certain advanced visualization techniques based on the user's ultimate goals. In some cases, the controller 104 prioritizes outputting a smooth and high-definition color video stream to the user above other advanced visualization techniques. In other cases, the controller 104 prioritizes one or more advanced visualization techniques over color visualization, and in these cases, the output color video stream may appear choppy to a human eye because the system outputs fewer than 30 fps of color imaging data.

For example, a user may indicate that a fluorescent reagent has been administered to a patient. If the fluorescent reagent is time sensitive, then the controller 104 may ensure that a sufficient ratio of frames is devoted to fluorescence imaging to ensure the user receives adequate fluorescence imaging data while the reagent remains active. In another example, a user requests a notification whenever the user's tool comes within a threshold distance of a certain tissue, such as a blood vessel, nerve fiber, cancer tissue, and so forth. In this example, the controller 104 may prioritize laser mapping visualization to constantly determine the distance between the user's tool and the surrounding structures and may further prioritize multispectral or fluorescence imaging that enables the system to identify the certain tissue. The controller 104 may further prioritize color visualization to ensure the user continues to view a color video stream of the scene.

FIGS. 3A-3C illustrate schematic diagrams of a system 300 for processing data output by an image sensor 124 comprising the pixel array 125. The system 300 includes a controller 104 in communication with each of the emitter 102 and the image sensor 124 comprising the pixel array 125. The emitter 102 includes one or more visible sources 304, multispectral waveband sources 306, fluorescence waveband sources 308, and mapping pattern sources 310 of EMR.

The pixel array data readout 342 of the image sensor 124 includes one or more of color imaging data 305, multispectral imaging data 307, fluorescence imaging data 309, or mapping data 311. The color imaging data 305 may include one or more of a color data frame 205 captured in a time-division system configuration as illustrated in FIGS. 2A-2C or color imaging data captured with a color filter array (CFA) or multispectral filter array (MSFA). The multispectral imaging data 307 may include one or more of a multispectral data frame 207 captured in a time-division system configuration as illustrated in FIGS. 2A-2C or multispectral imaging data captured with a MSFA. The fluorescence imaging data 309 may include one or more of a fluorescence data frame 209 captured in a time-division system configuration as illustrated in FIGS. 2A-2C or fluorescence imaging data captured with a MSFA. The mapping data 311 may include one or more of a mapping data 211 or mapping data calculated with stereoscopic imaging.

When the pixel array 125 is equipped with a MSFA, the color imaging data 305 may be captured simultaneously with one or more of the multispectral imaging data 307, the fluorescence imaging data 309, or the mapping data 311. These data types may be captured simultaneously according to the time-division system configuration discussed in connection with FIGS. 2A-2C, or with a constant illumination system configuration. The type of data extracted from the pixel array data readout 342 will be depending on which EMR sources 134, 138 are cycled on by the emitter 102 during. The emitter 102 may selectively actuate any of visible sources 304, multispectral waveband sources 306, fluorescence waveband sources 308, or mapping pattern sources 310.

When data is captured according to the time-division configuration of FIGS. 2A-2C, the emitter 102 may be instructed to simultaneously cycle on the white EMR source 134 and one or more other EMR sources 138 during a blanking period of the image sensor 124. The one or more other EMR sources 138 may be tuned to emit only EMR within a narrow waveband selected for fluorescence or multispectral visualization. In this configuration, the pixel array 125 with the MSFA may simultaneously capture color visualization data and fluorescence/multispectral visualization data during a single frame period (i.e., a readout period and a blanking period).

In an alternative implementation, the emitter 102 continuously emits one or more EMR sources, including the white EMR source 134 or any of the narrowband EMR sources 138. The emitter 102 may cycle various EMR sources 134, 138 on an off based on user preferences and which datatypes are sought (i.e., color imaging data 305, multispectral imaging data 307, fluorescence imaging data 309, mapping data 311). In this implementation, the pixel array 125 equipped with the MSFA may simultaneously capture color visualization data and fluorescence/multispectral visualization data during each frame period.

As illustrated in FIG. 3B, all data read out by the pixel array may undergo frame correction 344 processing by the image signal processor 140. In various implementations, one or more of the color imaging data 305, the multispectral imaging data 307, the fluorescence imaging data 309, and the mapping data 311 undergoes frame correction 344 processes. The frame correction 344 includes one or more of sensor correction, white balance, color correction, or edge enhancement.

The multispectral imaging data 307 may undergo spectral processing 346 that is executed by the image signal processor 140 and/or another processor that is external to the system 300. The spectral processing 346 may include a machine learning algorithm and may be executed by a neural network configured to process the multispectral imaging data 307 to identify one or more tissue structures within a scene based on whether those tissue structures emitted a spectral response. The spectral processing 346 assesses the pixel integration (accumulation) values for each pixel within the pixel array 125 and may specifically assess the pixel integration values for pixels equipped with an appropriate spectral filter. The pixel integration values will inform the spectral processing 346 algorithm whether a certain pixel likely accumulated a spectral response for a certain tissue, disease, condition, chemical process, biological process, and so forth.

The fluorescence imaging data 309 may undergo fluorescence processing 348 that is executed by the image signal processor 140 and/or another processor that is external to the system 300. The fluorescence processing 348 may include a machine learning algorithm and may be executed by a neural network configured to process to fluorescence imaging data 309 and identify an intensity map wherein a fluorescence relaxation wavelength is detected by the pixel array. The fluorescence processing 348 assesses the pixel integration (accumulation) values for each pixel within the pixel array 125 and may specifically assess the pixel integration values for pixels equipped with an appropriate spectral filter. The pixel integration values will inform the fluorescence processing 348 algorithm whether a certain pixel likely accumulated a fluorescence relaxation emission by a reagent or tissue.

The mapping data 311 may undergo topographical processing 350 that is executed by the image signal processor 140 and/or another processor that is external to the system 300. The topographical processing 350 may include a machine learning algorithm and may be executed by a neural network configured to assess time-of-flight information to calculate a depth map representative of the scene. The topographical processing 350 includes calculating one or more of a three-dimensional topographical map of the scene, a dimension of one or more objects within the scene, a distance between two or more objects within the scene, a distance between a tool and a certain tissue structure within the scene, and so forth.

The topographical processing 350 may additionally or alternatively be based on stereoscopic visualization. The topographical processing 350 may execute stereo imaging triangulation to calculate three-dimensional coordinates of points in a scene using two or more data frames captured from different viewpoints. This is calculated based on the principle of triangulation, which includes measuring relative positions and angles of image sensor 124 viewpoints using the resulting parallax information to determine the depth or distance of objects within a scene. In this case, the topographical processing 350 may include correspondence matching of features in two or more images, disparity estimation, depth calculation, and three-dimensional reconstruction.

FIG. 3C illustrates a schematic diagram of a system 300 and process flow for managing data output at an irregular rate. The image sensor 124 operates according to a sensor cycle that includes blanking periods and readout periods. The image sensor 124 outputs a data frame at the conclusion of each readout period that includes an indication of the amount of EMR the pixel array accumulated during the preceding accumulation period or blanking period.

Each frame period in the sensor cycle is adjustable on a frame-by-frame basis to optimize the output of the image sensor and compensate for the pixel array 125 having varying degrees of sensitivity to different wavebands of EMR. The duration of each blanking period may be shortened or lengthened to customize the amount of EMR the pixel array 125 can accumulate. Additionally, the duration of each readout period may be shortened or lengthened by implementing a pixel binning configuration or causing the image sensor to read out each pixel within the pixel array 125. Thus, the image sensor 124 may output data frames at an irregular rate due to the sensor cycle comprising a variable frame rate. The system 300 includes a memory buffer 352 that receives data frames from the image sensor 124. The memory buffer 352 stores the data frames and then outputs each data frame to the image signal processor 140 at a regular rate. This enables the image signal processor 140 to process each data frame in sequence at a regular rate.

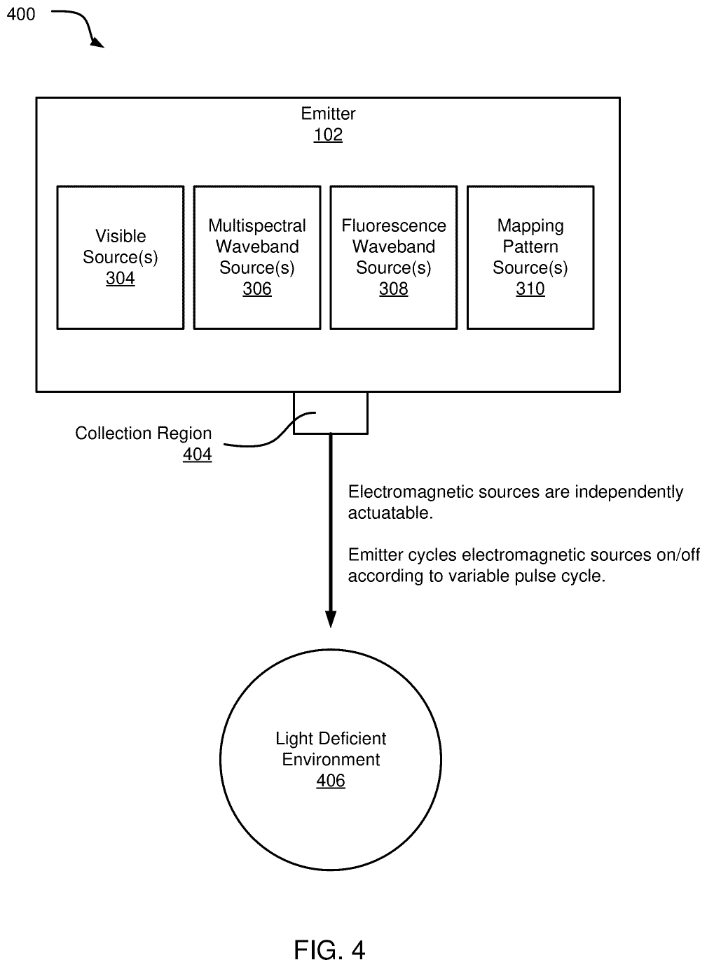

FIG. 4 is a schematic diagram of an illumination system 400 for illuminating a light deficient environment 406 such as an interior of a body cavity. In most cases, the emitter 102 is the only source of illumination within the light deficient environment 406 such that the pixel array of the image sensor does not detect any ambient light sources. The emitter 102 includes a plurality of separate and independently actuatable sources of EMR, which may include visible source(s) 304, multispectral waveband source(s) 306, fluorescence waveband source(s) 308, and mapping pattern source(s) 310. The emitter may cycle a selection of the sources on and off to pulse according to the variable pulse cycle received from the controller 104. Each of the EMR sources feeds into a collection region 404 of the emitter 102. The collection region 404 may then feed into a waveguide (see e.g., 130 in FIG. 1A) that transmits the pulsed EMR to a distal end of an endoscope within the light deficient environment 406.

The variable pulsing cycle is customizable and adjustable in real-time based on user input. The emitter 102 may instruct the individual EMR sources to pulse in any order. Additionally, the emitter 102 may adjust one or more of a duration or an intensity of each pulse of EMR. The variable pulse cycle may be optimized to sufficiently illuminate the light deficient environment 406 such that the resultant data frames read out by the pixel array 125 are within a desired exposure range (i.e., the frames are neither underexposed nor overexposed). The desired exposure range may be determined based on user input, requirements of the image signal processor 140, and/or requirements of a certain image processing algorithm (see 344, 346, 348, and 350 in FIG. 3B). The sufficient illumination of the light deficient environment 406 is dependent on the energy output of the individual EMR sources and is further dependent on the efficiency of the pixel array 125 for sensing different wavebands of EMR.

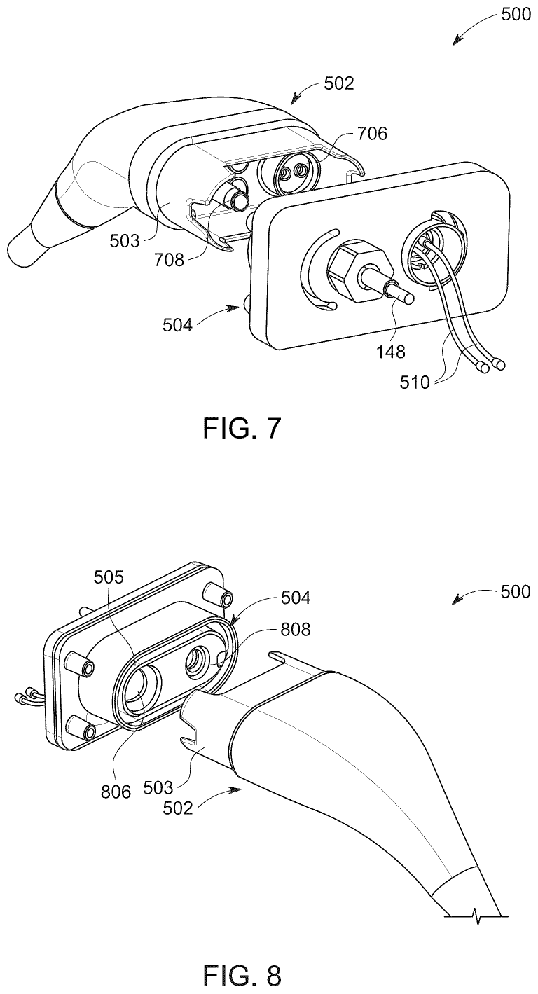

FIGS. 5-15, 15-16, and 17A-17D illustrate various views of components of a connector module 500 for establishing optical and electronic communications between components of an endoscopic visualization system, such as the system 100 first discussed in connection with FIGS. 1A-1C. Specifically, FIG. 5 is a perspective view of an exterior of the connector module 500, illustrating a cable connector plug 502 aligned with a cable connector receptacle 504 that is installed within a housing for the emitter 102. FIG. 6 is a zoomed-in view of the same perspective view shown in FIG. 5. FIG. 7 is a perspective view of the connector module 500, and specifically illustrates an exterior view of the cable connector plug 502 and an interior view of the cable connector receptacle 504. FIG. 8 is a perspective view of the connector module 500, and specifically illustrates an exterior view of the cable connector plug 502 and an interior view of the cable connector receptacle 504.

The connector module 500 comprises the cable connector plug 502 and the cable connector receptacle 504. The cable connector plug 502 is disposed at a distal end of the endoscope 110 (as first shown in FIG. 1A) or the tool 108 (as first shown in FIG. 1A) and enables a user to connect the endoscope 110 or tool 108 to the emitter 102 and controller 104. The cable connector receptacle 504 is disposed within a housing of the emitter 102 and controller 104. The cable connector plug 502 includes an alignment shroud 503 that assists a user in correctly guiding the cable connector plug 502 into the cable connector receptacle. The cable connector receptacle 504 includes a corresponding alignment receptacle 505, which comprises an empty negative space configured to receive the alignment shroud 503. The alignment receptacle 505 is defined by two sidewalls forming a negative space that is appropriately sized and shaped for receiving the alignment shroud 503.

In some implementations, the connector module 500 is a glass-to-metal seal (GTMS) connector that includes an optical connector and a data connector. The optical connector is configured to transport multiple wavebands of EMR from the emitter 102 to a distal end of the endoscope 110. This may include the emissions by any of the white EMR source 134, the various narrowband or broadband EMR sources 138, or the mapping source 142. The connector module 500 additionally includes a pair of data connectors, such as a quick connect BNC connector, for powering the endoscope 110 and enabling high frequency bidirectional data communication.

The connector module 500 serves as a coupling point or coupling interface that enables an endoscope 110 to be connected to the emitter 102 and/or controller 104. The connector module 500 enables EMR to pass between the waveguide 130 of the endoscope 110 and the emitter 102. The connector module 500 additionally allows data to pass between the controller 104 and one or more of the MCU 122 or the image sensor 124 of the endoscope 110.

The alignment shroud 503 serves as a protective and guiding component designed to assist in aligning the cable connector plug 502 with the cable connector receptacle 504. The alignment shroud 503 ensures the two parts 502, 504 fit together correctly and prevents misalignment that could damage components or result in an improper connection.

The cable connector plug 502 includes a first data coupler 706 and a fiber optic post 708. The first data coupler 706 is in electronic communication with electronic components of the endoscope 110 or tool 108. The first data coupler 706 may facilitate communication of, for example, data output by the image sensor 124, data output by the MCU 122, or data output by the controller 104. The fiber optic post 708 enables EMR to pass between the emitter 102 and a waveguide 130, 131 of the endoscope 110 or tool 108.

The cable connector receptacle 504 includes a second data coupler 806 and a fiber optic socket 808. The second data coupler 806 corresponds with the first data coupler 706 disposed on the cable connector plug 502. The fiber optic socket 808 corresponds with the fiber optic post 708 disposed on the cable connector plug 502. In some cases, the corresponding components may be reversed, such that the first data coupler 706 is disposed on the cable connector receptacle 504 and the second data coupler 806 is disposed on the cable connector plug 502; or such that the fiber optic post 708 is disposed on the cable connector receptacle 504 and the fiber optic socket 808 is disposed on the cable connector plug 502. The second data coupler 806 is in electrical communication with an electronic cable 510 that enables data transmission to components of the controller 104. The fiber optic socket 808 includes a jumper waveguide 148 disposed therein, wherein the jumper waveguide 148 carries EMR between the fiber optic socket 808 and an EMR source 134, 138, 142 of the emitter 102.

The connector module 500 is configured to ensure the endoscope 110 or tool 108 is safely and securely plugged into the emitter 102 and/or controller 104 without damaging any electrical components or fiber optic components. The connector module 500 includes alignment guides to aid a user in pre-aligning the cable connector plug 502 with the cable connector receptacle 504. These alignment guides prevent the user from inserting the cable connector plug 502 in the wrong orientation, which could lead to damaging either of the electrical components 706, 806 or the fiber optic components 708, 808.

The connector module 500 is constructed with mechanical rigidity to withstand frequent connect-disconnect cycles. The dimensions of the alignment shroud 503, alignment receptacle 505, and various sockets and plugs 706, 806, 708, 808 are all optimized to ensure mating accuracy and sufficient retention mechanisms to prevent the cable connector plug 502 from inadvertently disengaging from the cable connector receptacle 504. The fiber optic post 708 and fiber optic socket 808 components provide optical coupling efficiency at the emitter 102 to ensure complete or near-complete optical throughput from the emitter 102 to the distal end of the endoscope 110.

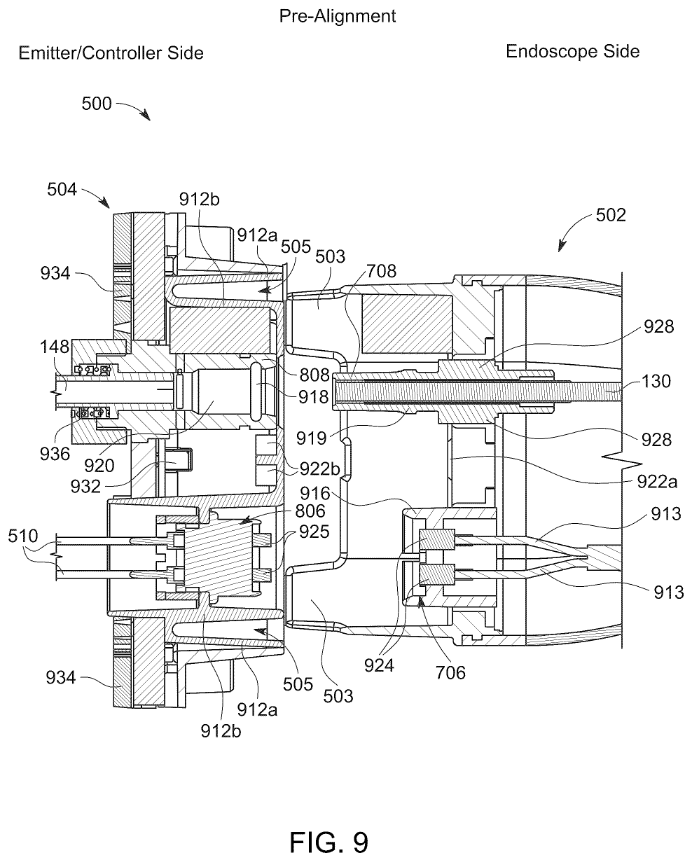

FIG. 9 illustrates a top-down cross-sectional view of the connector module 500 at a pre-alignment phase in the insertion sequence. As shown in FIG. 9, the alignment shroud 503 of the cable connector plug 502 has not yet engaged with the alignment receptacle 505 of the cable connector receptacle 504.

The connector module 500 is designed to sequentially (rather than simultaneously) couple the optical components and the data components. The insertion sequence for the cable connector plug 502 begins with the pre-alignment phase, when the alignment shroud 503 is aligned with the alignment receptacle 505. This pre-alignment of the alignment shroud 503 and the alignment receptacle 505 prevents the fiber optic components from colliding with one another and further prevents the data connection components from engaging incorrectly. The insertion sequence continues with engaging the optical components of the connector module 500. When the alignment shroud 503 and alignment receptacle 505 are engaged, the clearance is minimized to limit the lateral decentration or excess tilt of the cable connector plug 502, and this leads to a mechanical interference between the fiber optic post 708 and the fiber optic socket 808. The insertion sequence continues with the data coupling components, including the first data coupler 706 and the second data coupler 806.

The connector module 500 includes optical coupling components, which includes at least the fiber optic post 708 and the corresponding fiber optic socket 808. The connector module 500 additionally includes data coupling components, which includes at least the first data coupler 706 and the corresponding second data coupler 806. The connector module 500 is designed to ensure the optical coupling components engage with one another before the data coupling components engage with one another.

The optical coupling components and the data coupling components of the cable connector plug 502 are protected by the alignment shroud 503. The alignment shroud 503 comprises a proximal end that is attached to the cable, and further comprises a distal end that constitutes the tip of the alignment shroud 503 (i.e., the end of the alignment shroud 503 that first engages with the alignment receptacle 505). The alignment shroud 503 is sized to ensure that the alignment shroud 503 is the first component of the cable connector plug 502 that engages with the cable connector receptacle 504. The alignment shroud 503 aids in ensuring proper alignment of all coupling components to mitigate the risk that any of the optical or data coupling components are damaged during insertion.

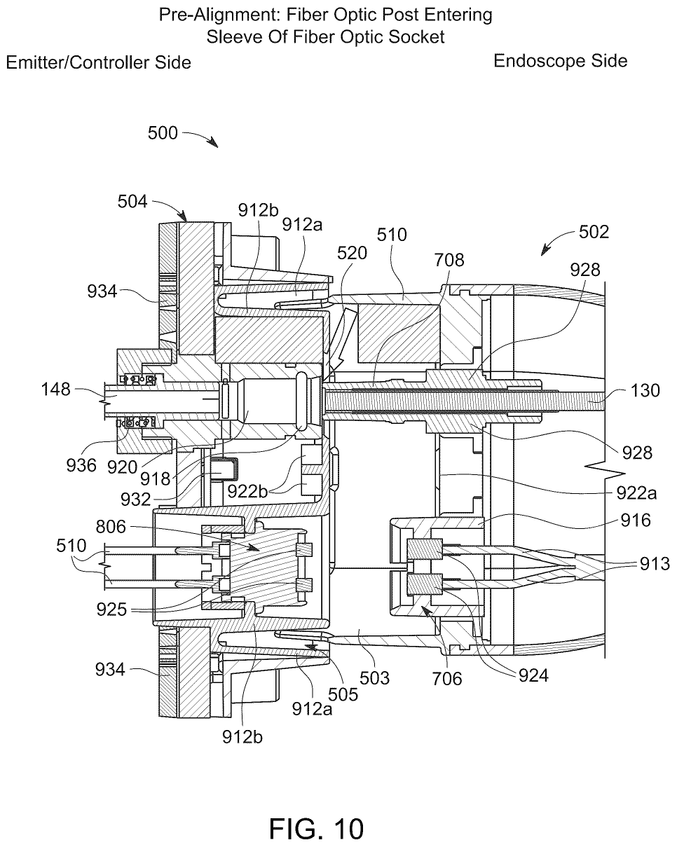

After the alignment shroud 503 is partially inserted into the alignment receptacle 505, the optical coupling components will begin to engage with each other (as illustrated at least in FIG. 10). This includes the fiber optic post 708 (on the cable connector plug 502 side) and the fiber optic socket 808 (on the cable connector receptacle 504 side). A fiber optic sleeve 920 is disposed within the fiber optic socket 808, and the fiber optic sleeve 920 is configured to securely receive the fiber optic post 708 such that an interference fit is formed between an external wall of the fiber optic post 708 and an internal wall of the fiber optic sleeve 920. When the optical coupling components are fully coupled with one another, EMR can travel from the emitter 102 to a distal end of the endoscope 110 with minimal losses. As shown in FIG. 9, the fiber optic post 708 encases a portion of the fiber optic waveguide 130 that will run the length of the endoscope 110 and terminate at a distal end of the endoscope 110. The fiber optic sleeve 920 encases a portion of an emitter jumper waveguide 148 that is in optical communication with one or more of a collection region for the EMR sources 134, 138, 142 or in direct optical communication with the EMR sources 134, 138, 142 themselves.

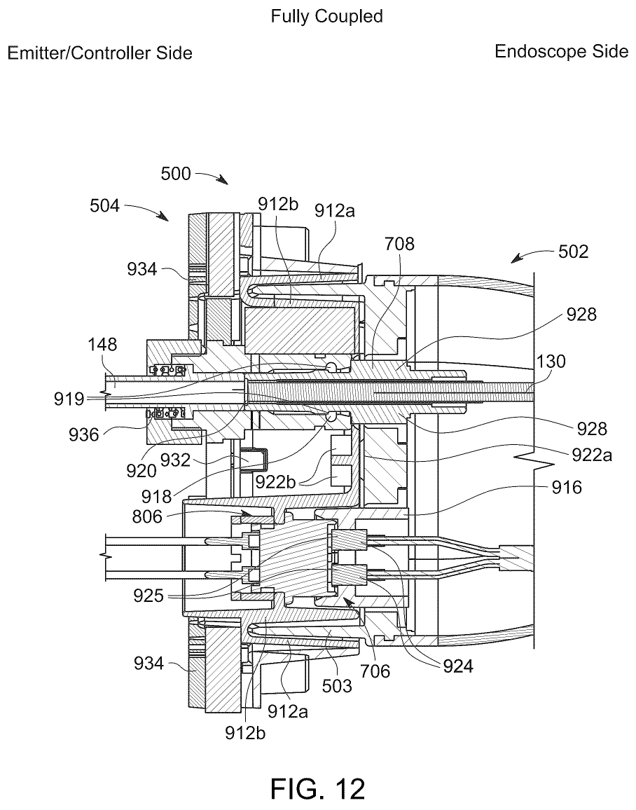

After the optical coupling components are engaged with one another, the data coupling components will begin to engage with each other (as illustrated at least in FIG. 12). This includes the first data coupler 706 (on the cable connector plug 502 side) and the second data coupler 806 (on the cable connector receptacle 504 side). The first data coupler 706 is in electronic communication with electronic cables 913 that will run down at least a portion of the length of the endoscope 110. These electronic cables 913 facilitate electronic/data communication with at least the MCU 122 and the image sensor 124. The second data coupler 806 is in electronic communication with one or more electronic cables 510 that run to the controller 104. These electronic cables 510 facilitate electronic/data communication with one or more components of the controller 104, such as the FPGA 112 and the computer 113.

Regarding the optical coupling components, the fiber optic post 708 locks into place within the fiber optic socket 808 with the aid of a coiled spring 918. The coiled spring 918 is disposed around an external circumference of the fiber optic sleeve 920. The cross-sectional view of FIG. 9 illustrates an entire circumference of the fiber optic sleeve 920 and the coiled spring 918 disposed around the circumference of the fiber optic sleeve 920. The coiled spring 918 may specifically include a Bal Seal® coiled spring that provides both sealing and electric conductivity. The coiled spring 918 is a canted-coil spring such that individual coils are slanted or angled relative to an axis of the coiled spring 918. This ensures the coiled spring 918 provides consistent and even force when compressed, and this translates to reliable sealing and conductivity. The coiled spring 918 may be manufactured from electrically conductive materials to ensure electrical communication even when surrounding components (like the sleeve 920 and fiber optic post 708) experience motion or misalignment. The coiled spring 918 may also be utilized to shield from electromagnetic interference (EMI) and radio frequency interference (RFI).

When the fiber optic post 708 is fully disposed within the fiber optic sleeve 920 (see, e.g., FIG. 12), the coiled spring 918 will be disposed “behind” a coupling ridge 919 that is formed into an exterior of the fiber optic post 708. When the coiled spring 918 is behind the coupling ridge 919 as shown in FIG. 12, the coiled spring 918 and the coupling ridge 919 form a butt coupling with each other. This aids in locking the fiber optic post 708 into place within the fiber optic sleeve 920 and prevents the fiber optic post 708 from unintentionally slipping out of the fiber optic sleeve 920 when the system is in use.

The fiber optic post 708 additionally includes a coupling stop 928 extending outward relative to a longitudinal axis of the fiber optic post 708. The coupling stop 928 extends outward a sufficient distance such that the fiber optic post 708 is prevented from being depressed farther into the fiber optic sleeve 920 when the coupling post 928 buts against an edge of the fiber optic sleeve 920. As shown in FIG. 9, the coupling stop 928 extends outward from the longitudinal axis of the fiber optic post 708 a longer distance than the coupling ridge 919. This ensures that the coupling ridge 919 can be fully disposed within the fiber optic sleeve 920.

The optical coupling components further include an insertion spring 936 located internally to the housing for the emitter 102 and/or controller 104. The insertion spring 936 provides a spring-loaded mechanism to aid in forming a tight butt joint between the jumper waveguide 148 and the waveguide 130. The insertion spring 936 is configured to relax and thereby press the fiber optic sleeve 920 tightly against the coupling stop 928 of the fiber optic post 708. The insertion spring 936 is set around the jumper waveguide 148 and contained within a hollow body. This type of spring, which is set around the jumper waveguide 148, is restricted from lateral movement and can only be compressed or decompressed. This creates a consistent compressive force on the fiber optic post 708.

Regarding the data coupling components, the first data coupler 706 and the second data coupler 806 releasably engage with each other through the use of quick-connect connector. The quick-connect connector may specifically include a BNC (Bayonet Neil-Concelman) connector. The quick-connect connector comprises a male quick-connect 924 installed within the cable connector plug 502 and a female quick-connect 925 installed within the cable connector receptacle 504. It should be understood that the location of the male quick-connect 924 and female quick-connect 925 may be reversed without departing from the scope of the disclosure. The quick-connect connector 924, 925 is a radiofrequency connector that may be utilized for coaxial cable, and it is characterized by a two-stud bayonet-type locking mechanism. The bayonet-style locking mechanism provides a secure connection that can be quickly connected or disconnected. When the male quick-connect 924 is successfully engaged with the female quick-connect 925, data can bidirectionally pass between the endoscope 110 and the controller 104, and the insertion of the cable connector plug 502 into the cable connector receptacle 504 is complete.

The data coupling components further include a data connector shroud 916 that aids in the alignment of the first data coupler 706 and the second data coupler 806. The data connector shroud 916 serves as an outer protective casing or housing for data connection components that facilitate data exchange between the endoscope 110 (specifically, the MCU 122 and/or the image sensor 124) and the controller 104. The data connector shroud 916 provides mechanical protection for the delicate pins or contacts inside the male quick-connect 924 and the female quick-connect 925 (when the female quick-connect 925 is coupled to the male quick-connect 924), and additionally plays a role in shielding the internal connections from electromagnetic interference (EMI). That data connector shroud 916 provides strain relief to prevent tension on the cables (see 510, 913) from being transferred to internal contacts. This prolongs the life of the data connection components and reduces the risk of intermittent or failed connections.

As shown in FIG. 9, the alignment receptacle 505 of the cable connector receptacle 504 includes a receptacle internal shroud 912b and a receptacle external shroud 912a. The external and internal shrouds 912a, 912b form the negative space of the alignment receptacle 505. The external and internal shrouds 912a, 912b may form an interference fit with the alignment shroud 503 when the alignment shroud is disposed therein. The alignment receptacle 505 and alignment shroud 503 enable a user to pre-align the cable connector plug 502 with the cable connector receptacle 504 prior to coupling the fiber optic or data connection components.

The external and internal shrouds 912a, 912b are manufactured with ribs along the surface that ensure the cable connector plug 502 can be pressed into the cable connector receptacle 504 only when the cable connector plug 502 is oriented with the correct orientation. This prevents a user from pressing the cable connector plug 502 into the cable connector receptacle 504 when the cable connector plug 502 is held with the incorrect orientation relative to the orientation of the cable connector receptacle 504.

The connector module 500 includes a pair of magnets 922a, 922b that aid in releasably holding the cable connector plug 502 within the cable connector receptacle 504. A first magnet 922a (or magnetic material) is disposed on a surface of the cable connector plug 502. One or more second magnets 922b (or magnetic material) is disposed on a surface of the cable connector receptacle 504. When the cable connector plug 502 is fully plugged into the cable connector receptacle 504, the magnets 922a, 922b will attract to one another and provide an additional means of preventing the cable connector plug 502 from being pulled from the cable connector receptacle 504 unintentionally.

The connector module 500 includes a presence sensor 932 disposed within the cable connector receptacle 504. The presence sensor 932 is triggered when latching successfully occurs. The latching includes one or more of the magnets 922a, 922b engaging with one another, the coiled spring 918 forming a butt coupling with the coupling ridge 919, or engagement of the male quick-connect 924 and female quick-connect 925. When the presence sensor 932 is triggered, the controller 104 and/or the MCU 122 may be notified that the endoscope 110 is successfully plugged into the emitter 102/controller 104. The presence sensor 932 can be activated through multiple mechanisms, including, for example, magnetic, photoelectric, fiber optic, and so forth. The presence sensor 932 includes an option to program the system a notification indicating the system is fully connected. The connection with the presence sensor 932 may be communicated via a light on a front panel of the emitter 102.

The connector module 500 includes a heat sink 934 formed on a base of the cable connector receptacle 504. The heat sink 934 is configured to dissipate heat that is accumulated at the coupling interface between the cable connector plug 502 and the cable connector receptacle 504.

FIG. 10 illustrates a top-down cross-sectional view of the connector module 500 at a pre-alignment phase of the insertion sequence when the fiber optic post 708 is entering the sleeve 920 of the fiber optic socket 808. As shown in FIG. 10, the alignment shroud 503 begins to enter the alignment receptacle 505 before the corresponding optical coupling components engage with one another. Further as shown in FIG. 10, when the optical coupling components first begin to engage with one another, the data coupling components (e.g., male quick-connect 924 and female quick-connect 925) still have not engaged with one another.

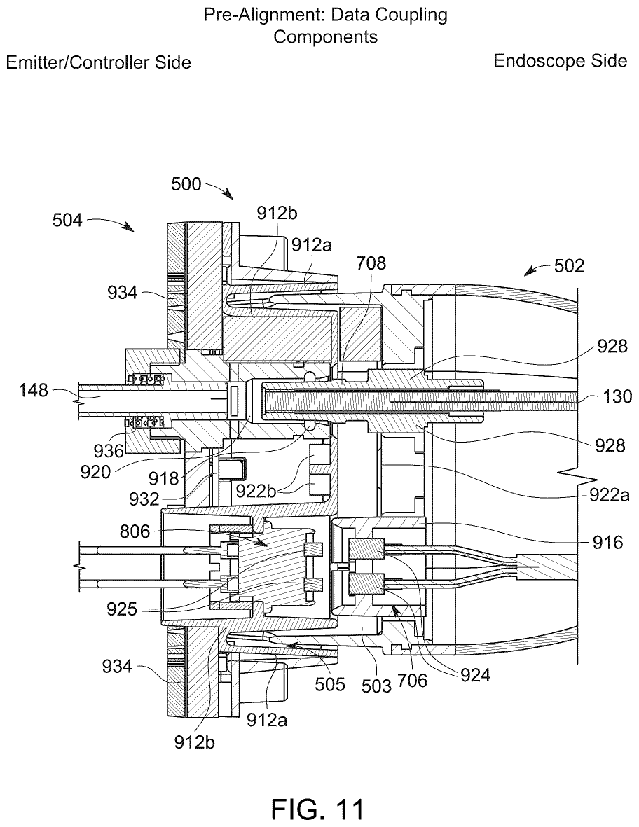

FIG. 11 illustrates a top-down cross-sectional view of the connector module 500 at a pre-alignment phase of the insertion sequence when the data connector shroud 916 begins to engage with the cable connector receptacle 504.

FIG. 12 illustrates a top-down cross-sectional view of the connector module 500 when the cable connector plug 502 and the cable connector receptacle 504 are fully coupled. As shown in FIG. 12, the corresponding optical coupling components and the corresponding data coupling components are fully coupled to one another. This enables EMR to be transmitted from the emitter 102 to a distal end of the endoscope 110, and further enables data to bidirectionally pass between the endoscope 110 and the controller 104.

The insertion sequence for pressing the cable connector plug 502 into the cable connector receptacle 504 follows the phases illustrated in FIGS. 9-12. Namely, the alignment shroud 503 is first aligned with the corresponding alignment receptacle 505 as shown in FIG. 9. Then, then optical coupling components are aligned as shown in FIG. 10 such that the fiber optic post 708 begins to engage with the fiber optic sleeve 920. Then, the data coupling components are aligned as shown in FIG. 11, such that the data connector shroud 916 begins to engage with the housing for the second data coupler 806. Finally, the corresponding optical coupling components are fully coupled with one another, and the corresponding data coupling components are fully coupled with one another, as shown in FIG. 12. In this fully coupled arrangement, the fiber optic post 708 is fully disposed within the fiber optic sleeve 920, and the male quick-connect 924 is connected to the female quick-connect 925. This enables optical and data communication between the endoscope 110 and the emitter 102/controller 104 with minimal losses. The connector module 500 is configured to minimize a user's ability to tile or decenter the cable connector plug 502 relative to the cable connector receptacle 504.

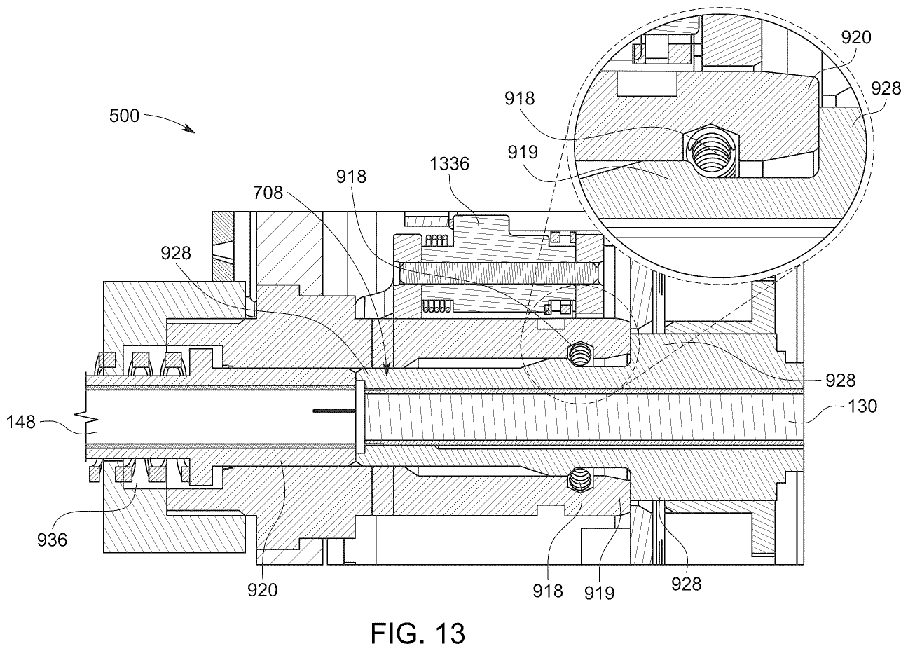

FIG. 13 illustrates a top-down cross-sectional view of a portion of the connector module 500, and specifically illustrates the optical coupling components of the connector module 500 in a fully coupled arrangement.

The connector module 500 includes an optical shutter 1336 that serves as a second laser-based safety measure. When the cable connector plug 502 is disconnected from the cable connector receptacle 504, the optical path of the optical shutter 1336 is closed. The optical shutter 1336 begins to open when the fiber optic post 708 is aligned with the sleeve 920 of the fiber optic coupler 515. The optical shutter 1336 is fully opened when the fiber optic post 708 is fully disposed within the fiber optic sleeve 920 and the coupling stop 928 buts up against an end of the fiber optic sleeve 920. The optical shutter 1336 is progressively opened as the fiber optic post 708 is pressed into the fiber optic sleeve 920.

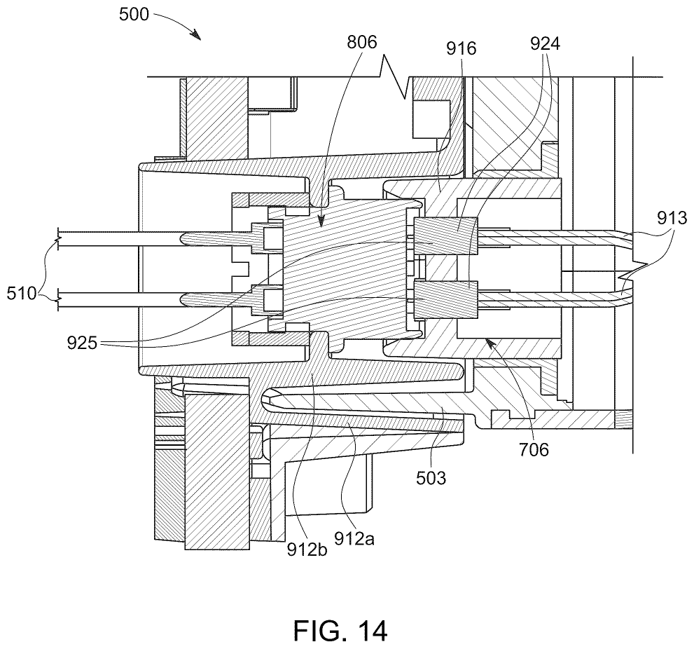

FIG. 14 illustrates a top-down cross-sectional view of a portion of the connector module 500, and specifically illustrates the data coupling components of the connector module 500 in a fully coupled arrangement. As shown in FIG. 14, the data connector shroud 916 engages with the second data coupler 806 before the corresponding male quick-connects 924 and female quick-connects 925 are coupled. The data connector shroud 916 thereby aids in aligning the corresponding quick-connects 924, 925 before the quick-connects 924, 925 touch one another.

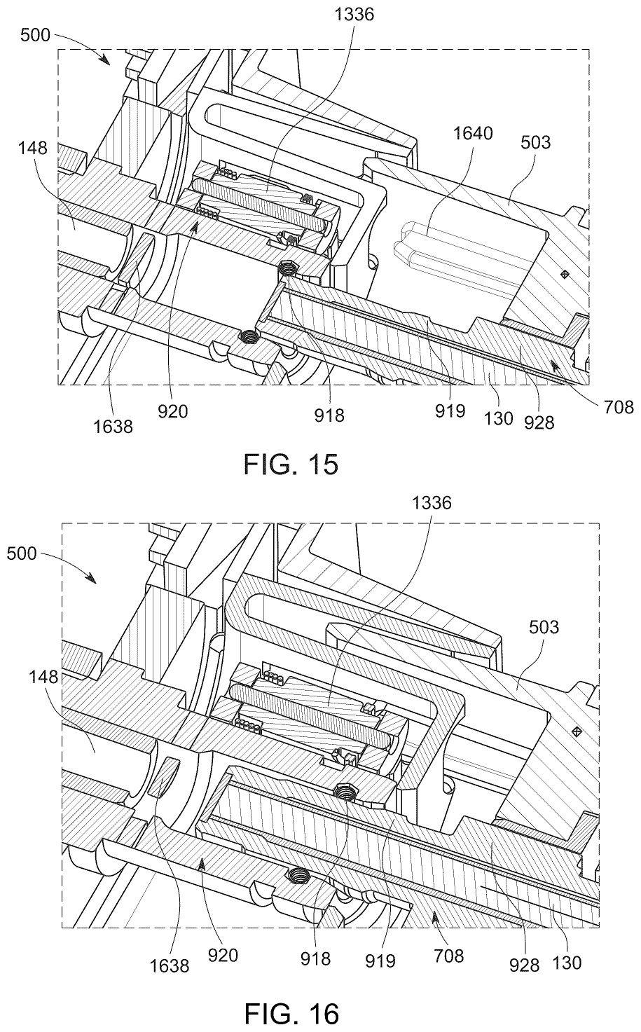

FIGS. 15 and 16 are perspective cross-sectional views of a portion of the connector module 500, and specifically illustrate a portion of the optical coupling components and the shutter. FIG. 16 illustrates wherein the cable connector plug 502 is depressed farther into the cable connector receptacle 504 when compared with the arrangement illustrated in FIG. 15. The optical shutter 1336 is progressively opened and closed when the fiber optic post 708 is pressed into the fiber optic sleeve 920. The optical shutter 1336 includes a shutter blade 1638 that comprises a geometry similar to a helical gear, such as a curved geometry or slanted wing geometry. The optical coupling components further includes an actuation rib 1640 within the alignment shroud 503 of the cable connector plug 502. The actuation rib 1640 presses along a longitudinal axis of the shutter blade 1638, the shutter blade 1638 then rotates, and this causes the optical shutter 1336 to rotate out of the way of the jumper waveguide 148, because the shutter blade 1638 is attached to the optical shutter 1336.

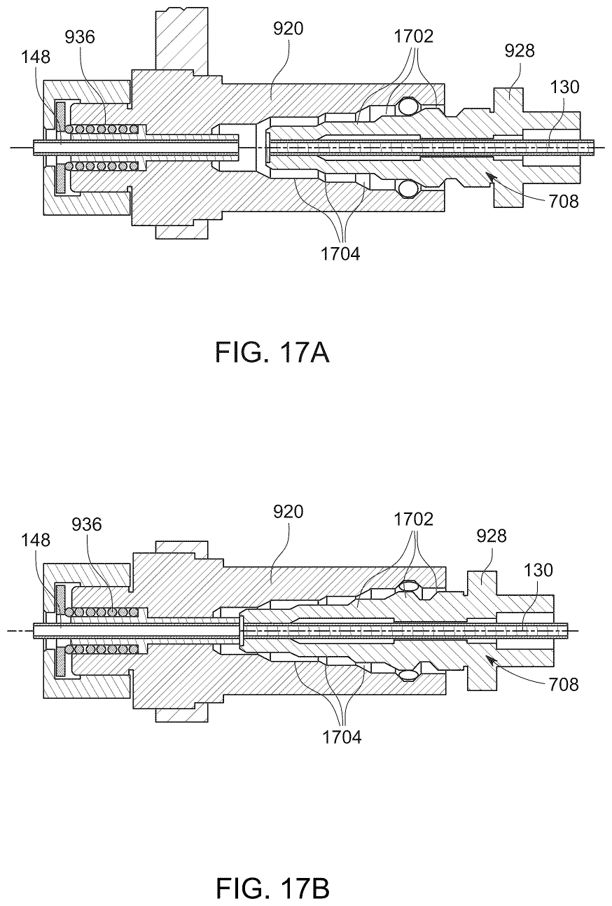

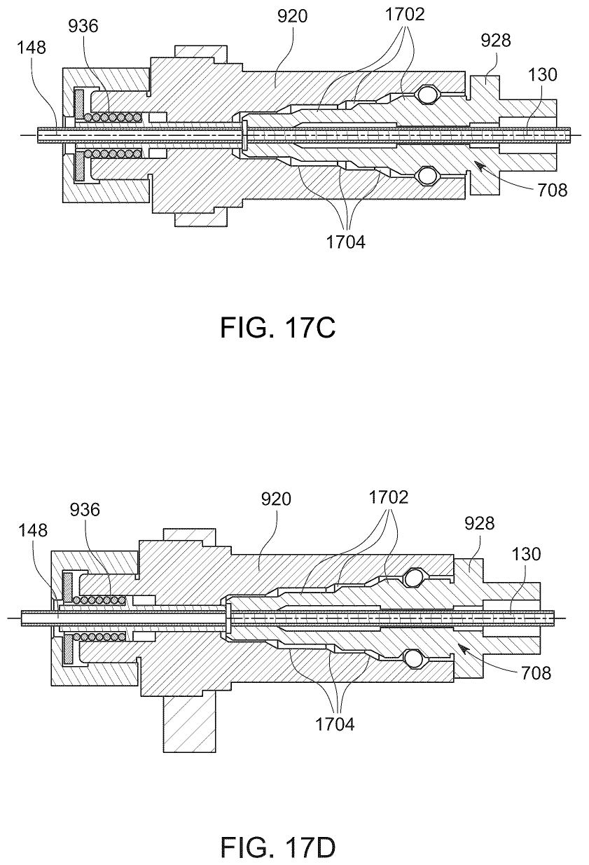

FIGS. 17A-17D illustrate schematic cross-sectional views of the optical coupling components of the connector module 500. Specifically, FIGS. 17A-17D illustrate wherein the fiber optic post 708 is depressed progressively farther into the fiber optic sleeve 920. The fiber optic post 708 comprises ridges 1702 machined into its outer circumference. The ridges 1702 serve to progressively narrow the circumference of the fiber optic post 708 from the coupling stop 928 down to its distal-most end (i.e., the end butting up against the jumper waveguide 148). Additionally, the fiber optic sleeve 920 comprises corresponding ridges 1704 machined into its internal circumference. The ridges 1704 of the fiber optic sleeve 920 conversely serve to widen the inner circumference of the fiber optic sleeve 920 from its proximal end (i.e., the end nearest the emitter 102 and/or controller 104 housing) to its distal end (i.e., the end butting up against the coupling stop 928 of the fiber optic post 708).

The ridges 1702, 1704 of the fiber optic post 708 and fiber optic sleeve 920 provide a user with some tilt tolerance when first inserting the fiber optic post 708 into the fiber optic sleeve 920. The tilt tolerance is diminished progressively as the cable connector plug 502 is pressed into the cable connector receptacle 504. The ridges 1702, 1704 of the fiber optic post 708 and the fiber optic sleeve 920 correspond with one another as shown in FIGS. 17A-17D such that an exterior wall of the fiber optic post 708 forms an interference fit with an interior wall of the fiber optic sleeve 920 when the fiber optic post 708 is fully inserted. This occurs when the coupling stop 928 butts against a distal end of the fiber optic sleeve 920. When the fiber optic post 708 is fully inserted within the fiber optic sleeve 920, the jumper waveguide 148 and the waveguide 130 form a tight butt joint with another to enable EMR to pass from the jumper waveguide 148 to the waveguide 130 with minimal losses.

### Examples

The following examples pertain to preferred features of further embodiments:

Example 1 is a system. The system includes a plug attached to a cable, wherein the plug comprises: an alignment shroud; a first fiber optic coupler; and a first data connector. The system includes a receptacle configured to receive the plug, wherein the receptacle comprises: an alignment receptacle configured to receive the alignment shroud, wherein the alignment receptacle is a negative space defined by a receptacle external shroud and a receptacle internal shroud; a second fiber optic coupler configured to interface with the first fiber optic coupler; and a second data connector configured to interface with the first data connector.

Example 2 is a system as in Example 1, wherein the alignment shroud comprises a proximal end and a distal end, and wherein the proximal end is disposed nearest to the cable; wherein, during insertion of the plug into the receptacle, the distal end of the alignment shroud is received by the alignment receptacle prior to coupling of the first fiber optic coupler and the second fiber optic coupler; and wherein, during the insertion of the plug into the receptacle, the distal end of the alignment shroud is received by the alignment receptacle prior to coupling of the first data connector and the second data connector.

Example 3 is a system as in any of Examples 1-2, wherein a distance between the receptacle external shroud and the receptacle internal shroud is optimized to form an interference fit between the alignment shroud, the receptacle external shroud, and the receptacle internal shroud.

Example 4 is a system as in any of Examples 1-3, wherein the first fiber optic coupler comprises a fiber optic post, and wherein a first fiber optic cable is disposed within an interior space of the fiber optic post; and wherein the second fiber optic coupler comprises a fiber optic sleeve.

Example 5 is a system as in any of Examples 1-4, wherein the fiber optic sleeve comprises a hollow interior space, and wherein a size of the hollow interior space is optimized to receive the fiber optic post.

Example 6 is a system as in any of Examples 1-5, wherein an external surface of the fiber optic post forms an interference fit with an interior surface of the fiber optic sleeve when the fiber optic post is disposed within the fiber optic sleeve.

Example 7 is a system as in any of Examples 1-6, wherein the second fiber optic coupler further comprises a coiled spring disposed around an external circumference of the fiber optic sleeve.

Example 8 is a system as in any of Examples 1-7, wherein the first fiber optic coupler further comprises a coupling ridge extending outward from the fiber optic post relative to a longitudinal axis of the fiber optic post; and wherein a size of the coiled spring and a size of the coupling ridge are optimized such that the coupling ridge prevents the fiber optic post from sliding out of the fiber optic sleeve after the first fiber optic coupler is fully coupled to the second fiber optic coupler.

Example 9 is a system as in any of Examples 1-8, wherein the first fiber optic coupler further comprising a coupling stop extending outward from the fiber optic post relative to the longitudinal axis of the fiber optic post; wherein the coupling stop extends outward from the longitudinal axis of the fiber optic post longer than the coupling ridge extends outward from the longitudinal axis of the fiber optic post; and wherein the coupling stop buts against the fiber optic sleeve to prevent the fiber optic post from being pressed farther into the fiber optic sleeve.

Example 10 is a system as in any of Examples 1-9, wherein the first data connector comprises a male quick-connect coupler with a bayonet locking mechanism; and wherein the second data connector comprises a female quick-connect coupler with a bayonet locking mechanism.

Example 11 is a system as in any of Examples 1-10, wherein the first data connector is housed within a data connector shroud; and wherein a size of the data connector shroud is optimized such that the data connector shroud touches a component of the receptacle before the first data connector is coupled to the second data connector.

Example 12 is a system as in any of Examples 1-11, wherein the first fiber optic coupler comprises a first waveguide; wherein the second fiber optic coupler comprises a second waveguide; wherein the first fiber optic coupler is configured to releasably couple with the second fiber optic coupler such that electromagnetic radiation is transmitted between the first waveguide and the second waveguide.

Example 13 is a system as in any of Examples 1-12, wherein the first waveguide is disposed within the cable and transmits the electromagnetic radiation to a distal end of an endoscope; and wherein the second waveguide transmits electromagnetic radiation emitted by one or more sources of electromagnetic radiation disposed within an emitter.

Example 14 is a system as in any of Examples 1-13, wherein the one or more sources of electromagnetic radiation disposed within the emitter comprises one or more of: a white light source that pulses electromagnetic radiation within a broadband visible waveband of electromagnetic radiation; a multispectral source that pulses electromagnetic radiation within a narrowband visible waveband of electromagnetic radiation, wherein the narrowband visible waveband is 40 nm wide or less; a multispectral source that pulses electromagnetic radiation within a narrowband infrared waveband of electromagnetic radiation, wherein the narrowband infrared waveband is 100 nm wide or less; or a fluorescence source that pulses electromagnetic radiation within a narrowband near infrared waveband of electromagnetic radiation, wherein the narrowband near infrared waveband is 40 nm wide or less.

Example 15 is a system as in any of Examples 1-14, wherein the first data connector is in direct electrical communication with a controller of an endoscopic visualization system that is located external to an endoscope; wherein the second data connector is in direct electrical communication with one or more of a microcontroller or an image sensor of the endoscopic visualization system that are located internal to the endoscope; and wherein coupling of the first data connector and the second data connector enables bidirectional communication between the controller and one or more of the microcontroller or the image sensor.

Example 16 is a system as in any of Examples 1-15, wherein the first fiber optic coupler comprises a fiber optic post comprising a fiber optic cable disposed within the fiber optic post; wherein a length of the fiber optic post is optimized such that the fiber optic post engages with the second fiber optic coupler before any component of the first data connector engages with any component of the second data connector.

Example 17 is a system as in any of Examples 1-16, wherein the receptacle further comprises a heat sink.

Example 18 is a system as in any of Examples 1-17, further comprising: a first magnet component disposed within the plug, wherein the first magnet component comprises a magnet or a magnetic material; and a second magnet component disposed within the receptacle, wherein the second magnet component comprises a magnet or a magnetic material; wherein the first magnet component is attracted to the second magnet component when the plug is fully disposed within the receptacle.

Example 19 is a system as in any of Examples 1-18, wherein the receptacle further comprises an optical shutter.

Example 20 is a system as in any of Examples 1-19, wherein an optical path of the optical shutter is closed when the plug is disconnected from the receptacle.

Example 21 is a system as in any of Examples 1-20, wherein the second fiber optic coupler of the receptacle further comprises a spring mechanism disposed around an exterior surface of the second fiber optic coupler, and wherein the spring mechanism is configured to aid in coupling the first fiber optic coupler to the second fiber optic coupler.

Example 22 is a system as in any of Examples 1-21, wherein at least one of the first data connector or the second data connector comprises a compliant material.

Example 23 is a system as in any of Examples 1-22, wherein the receptacle further comprises a presence sensor, and wherein the presence sensor is triggered when latching between the plug and the receptacle is successful.

Example 24 is a system as in any of Examples 1-23, wherein the presence sensor comprises detects one or more of: coupling of a magnet and a magnetic material indicating the plug is successfully plugged into the receptacle; or engagement of the first data connector with the second data connector; wherein the presence sensor notifies one or more of a controller or a microcontroller of an endoscope in response to determining the plug is successfully plugged into the receptacle.

Example 25 is a system as in any of Examples 1-24, wherein the receptacle is integrated into a housing of a light engine of an endoscopic visualization system, and wherein the second fiber optic coupler of the receptacle receives electromagnetic radiation emitted by an emitter disposed within the housing of the light engine.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system comprising:
a plug attached to a cable, wherein the plug comprises:
an alignment shroud;
a first fiber optic coupler; and
a first data connector; and
a receptacle configured to receive the plug, wherein the receptacle comprises:
an alignment receptacle configured to receive the alignment shroud, wherein the alignment receptacle is a negative space defined by a receptacle external shroud and a receptacle internal shroud;
a second fiber optic coupler configured to interface with the first fiber optic coupler; and
a second data connector configured to interface with the first data connector.

2. The system of claim 1, wherein the alignment shroud comprises a proximal end and a distal end, and wherein the proximal end is disposed nearest to the cable;
wherein, during insertion of the plug into the receptacle, the distal end of the alignment shroud is received by the alignment receptacle prior to coupling of the first fiber optic coupler and the second fiber optic coupler; and
wherein, during the insertion of the plug into the receptacle, the distal end of the alignment shroud is received by the alignment receptacle prior to coupling of the first data connector and the second data connector.

3. The system of claim 1, wherein a distance between the receptacle external shroud and the receptacle internal shroud is optimized to form an interference fit between the alignment shroud, the receptacle external shroud, and the receptacle internal shroud.

4. The system of claim 1, wherein the first fiber optic coupler comprises a fiber optic post, and wherein a first fiber optic cable is disposed within an interior space of the fiber optic post; and
wherein the second fiber optic coupler comprises a fiber optic sleeve.

5. The system of claim 4, wherein the fiber optic sleeve comprises a hollow interior space, and wherein a size of the hollow interior space is optimized to receive the fiber optic post.

6. The system of claim 5, wherein an external surface of the fiber optic post forms an interference fit with an interior surface of the fiber optic sleeve when the fiber optic post is disposed within the fiber optic sleeve.

7. The system of claim 4, wherein the second fiber optic coupler further comprises a coiled spring disposed around an external circumference of the fiber optic sleeve.

8. The system of claim 7, wherein the first fiber optic coupler further comprises a coupling ridge extending outward from the fiber optic post relative to a longitudinal axis of the fiber optic post; and
wherein a size of the coiled spring and a size of the coupling ridge are optimized such that the coupling ridge prevents the fiber optic post from sliding out of the fiber optic sleeve after the first fiber optic coupler is fully coupled to the second fiber optic coupler.

9. The system of claim 8, wherein the first fiber optic coupler further comprising a coupling stop extending outward from the fiber optic post relative to the longitudinal axis of the fiber optic post;
wherein the coupling stop extends outward from the longitudinal axis of the fiber optic post longer than the coupling ridge extends outward from the longitudinal axis of the fiber optic post; and
wherein the coupling stop buts against the fiber optic sleeve to prevent the fiber optic post from being pressed farther into the fiber optic sleeve.

10. The system of claim 1, wherein the first data connector comprises a quick-connect coupler with one or more of a plurality of pins or a locking mechanism; and
wherein the second data connector comprises a quick-connect coupler with one or more of a plurality of pin receptacles or a locking mechanism.

11. The system of claim 1, wherein the first fiber optic coupler comprises a first waveguide;
wherein the second fiber optic coupler comprises a second waveguide;
wherein the first fiber optic coupler is configured to releasably couple with the second fiber optic coupler such that electromagnetic radiation is transmitted between the first waveguide and the second waveguide;
wherein the first waveguide is disposed within the cable and transmits the electromagnetic radiation to a distal end of an endoscope; and
wherein the second waveguide transmits electromagnetic radiation emitted by one or more sources of electromagnetic radiation disposed within an emitter.

12. The system of claim 11, wherein the one or more sources of electromagnetic radiation disposed within the emitter comprises one or more of:
a white light source that pulses electromagnetic radiation within a broadband visible waveband of electromagnetic radiation;
a multispectral source that pulses electromagnetic radiation within a narrowband visible waveband of electromagnetic radiation, wherein the narrowband visible waveband is 40 nm wide or less;
a multispectral source that pulses electromagnetic radiation within a narrowband infrared waveband of electromagnetic radiation, wherein the narrowband infrared waveband is 100 nm wide or less; or
a fluorescence source that pulses electromagnetic radiation within a narrowband near infrared waveband of electromagnetic radiation, wherein the narrowband near infrared waveband is 40 nm wide or less.

13. The system of claim 1, wherein the first data connector is in direct electrical communication with a controller of an endoscopic visualization system that is located external to an endoscope;
wherein the second data connector is in direct electrical communication with one or more of a microcontroller or an image sensor of the endoscopic visualization system that are located internal to the endoscope; and
wherein coupling of the first data connector and the second data connector enables bidirectional communication between the controller and one or more of the microcontroller or the image sensor.

14. The system of claim 1, wherein the first fiber optic coupler comprises a fiber optic post comprising a fiber optic cable disposed within the fiber optic post;
wherein a length of the fiber optic post is optimized such that the fiber optic post engages with the second fiber optic coupler before any component of the first data connector engages with any component of the second data connector.

15. The system of claim 1, wherein the receptacle further comprises a heat sink.

16. The system of claim 1, further comprising:
a first magnet component disposed within the plug, wherein the first magnet component comprises a magnet or a magnetic material; and
a second magnet component disposed within the receptacle, wherein the second magnet component comprises a magnet or a magnetic material;
wherein the first magnet component is attracted to the second magnet component when the plug is fully disposed within the receptacle.

17. The system of claim 1, wherein the receptacle further comprises an optical shutter.

18. The system of claim 17, wherein an optical path of the optical shutter is closed when the plug is disconnected from the receptacle.

19. The system of claim 1, wherein the second fiber optic coupler of the receptacle further comprises a spring mechanism disposed around an exterior surface of the second fiber optic coupler, and wherein the spring mechanism is configured to aid in coupling the first fiber optic coupler to the second fiber optic coupler.

20. The system of claim 1, wherein at least one of the first data connector or the second data connector comprises a compliant material.

21. The system of claim 1, wherein the receptacle further comprises a presence sensor, and wherein the presence sensor is triggered when latching between the plug and the receptacle is successful.

22. The system of claim 21, wherein the presence sensor comprises detects one or more of:
coupling of a magnet and a magnetic material indicating the plug is successfully plugged into the receptacle; or
engagement of the first data connector with the second data connector;
wherein the presence sensor notifies one or more of a controller or a microcontroller of an endoscope in response to determining the plug is successfully plugged into the receptacle.

23. The system of claim 1, wherein the receptacle is integrated into a housing of a light engine of an endoscopic visualization system, and wherein the second fiber optic coupler of the receptacle receives electromagnetic radiation emitted by an emitter disposed within the housing of the light engine.
